(19) United States
(12) Patent Application Publication
(10) Pub. No.: US 2015/0252259 A1
(43) Pub. Date: Sep. 10, 2015

(54) ENHANCING UPCONVERSION LUMINESCENCE IN RARE-EARTH DOPED PARTICLES

(71) Applicant: Macquarie University, North Ryde (AU)

(72) Inventors: Dayong Jin, New South Wale (AU); Jiangbo Zhao, South Australia (AU)

(73) Assignee: MACQUARIE UNIVERSITY, North Ryde (AU)

(21) Appl. No.: 14/427,693

(22) PCT Filed: Sep. 17, 2013
(86) PCT No.: PCT/AU2013/001055

§ 371 Date: Mar. 12, 2015

(30) Foreign Application Priority Data
Sep. 17, 2012 (AU) 2012904043

(51) Int. Cl. C09K 11/77

(52) U.S. Cl. CPC C09K 11/7773

(57) ABSTRACT

Disclosed is a method for enhancing upconversion luminescence of rare-earth doped particles comprising a host material, an enriched concentration of activator (emitter) and a sufficient concentration level of sensitiser, the method comprising subjecting the particles to increased irradiance. The increased irradiance is higher than presently used relatively low irradiance levels. Enhancing upconversion luminescence involves enhancing luminescence intensity, brightness and/or upconversion efficiency. Particles are preferably subjected to an irradiance power density sufficient to overcome or reverse concentration quenching. The activator preferably has an intermediate meta stable energy level which accepts resonance energy from the sensitiser excited state level. In another form, particles are designed to minimize or exclude quenchers from the upconversion system between sensitizer and activator, such as the core-shell particles wherein the core comprises the host material, sensitiser and the activator, and the shell comprises a material which prevents, retards or inhibits surface quenching.

### TECHNICAL FIELD

The present invention broadly relates to methods, systems and/or particles for enhancing upconversion luminescence, preferably in particles doped with rare-earth metals.

### BACKGROUND OF THE INVENTION

Upconversion nanocrystals converting, for example, infrared radiation to higher-energy visible luminescence hold a significant promise for applications in bio-detection, bio-imaging, solar cells and 3-D display technologies. Lanthanide-doped upconversion nanocrystals are typically doped with ytterbium Yb³⁺ sensitiser ions which absorb infrared radiation and non-radiatively transfer sequential excitations to activator ions, such as Erbium (Er³⁺), Thulium (Tm³⁺) or Holmium (Ho³⁺). Traditionally, Er³⁺ ions which are resonant with Yb³⁺ ions and have quantum yield of 0.3% for upconversion luminescence, have been intensively investigated for biolabeling and background free imaging. Under low-irradiance excitation Tm³⁺ as an activator is not as bright as Er³⁺, however the infrared emissions of Tm³⁺ at about 802 nm lie in the “biological tissue transparency window”.

In an example upconversion system, luminescent lanthanide ions act as activators (also called emitters) but have a relatively small absorption cross-section to directly absorb incident infrared irradiation. As such, a sensitizer ion with much larger absorption cross-section at infrared (such as Yb) is employed as a type of antenna, which acts to transfer energy non-radiatively to the activators.

Although recent advances in synthesis have led to precise control of upconversion nanocrystal morphology, crystal phase and emission colours, it has remained difficult to achieve strong upconversion luminescence. Attempts to overcome this problem include using noble metal nanostructures to enhance the energy transfer rate by surface plasmons. A fundamental limitation is the concentration of sensitisers and activators cannot be increased beyond a relatively low threshold because this induces a significant decrease in luminescence which is known as “concentration quenching”. The optimised dopant concentrations in NaYF₄ host lattices have been determined to be in the range of 0.2˜0.5 mol % for Tm³⁺ and 20˜40 mol % for Yb³⁺. These values were established at low irradiance below 100 W/cm².

The present inventors have developed an understanding of the factors that contribute to concentration quenching in rare-earth doped particles, and have developed methods, systems and/or particles which enable concentration quenching to be minimised or avoided, so that, for example, more than thousands of emitters (and sensitizers) can be embedded into the upconversion nanocrystals, which gives amplified and exceptional brightness.

### SUMMARY OF THE INVENTION

In various forms, the present invention provides a method, system and/or particles, such as nanocrystals and microcrystals (considered as bulk materials), for enhanced upconversion luminescence, preferably using particles doped with rare-earth elements or metals.

In a first aspect the present invention provides a method for enhancing upconversion luminescence of rare-earth doped particles comprising a host material, a sensitiser and/or an activator, the method comprising subjecting the particles to increased irradiance or a minimum level of irradiance. In a particular example, the activator is present at high concentration and the sensitiser is present at sufficient concentration matching to the activator concentration.

The increased irradiance or the minimum level of irradiance is higher than presently used relatively low irradiance levels of below 100 W/cm².

Preferably, enhancing upconversion luminescence involves enhancing luminescence intensity and/or brightness and/or upconversion efficiency.

The method may comprise subjecting the particles to an irradiance which is sufficient to overcome or reverse concentration quenching of upconversion luminescence.

The method may comprise subjecting the particles to an irradiance which is sufficient to cause population of an upconversion energy state of the activator.

Preferably, the activator has an intermediate meta stable energy level which accepts resonance energy from the sensitiser excited state level.

The intermediate meta stable energy level may be below the sensitiser excited state level. Alternatively, the intermediate meta stable energy level may be above the sensitiser excited state level.

The particles may be configured to reduce, minimize or exclude quenchers from between the sensitiser and the activator.

The particles may be core-shell particles, wherein the core comprises the host material, highly-doped sensitiser and the activator, and the shell at least partially comprises, or consists of, one or more materials which prevent, retard or inhibit surface quenching.

The method may comprise subjecting the particles to an irradiance (i.e. an increased irradiance or a minimum level of irradiance) of at least about 10² W/cm², or at least about 10³ W/cm², or at least about 10⁴ W/cm², or at least about 10⁵ W/cm², or at least about 10⁶ W/cm², or at least about 10⁷ W/cm², or at least about 10⁸ W/cm², or at least about 10⁹ W/cm², or at least about 10¹⁰ W/cm², or at least about 10¹¹ W/cm², or at least about 10¹² W/cm².

The method may comprise subjecting the particles to an irradiance (i.e. an increased irradiance or a minimum level of irradiance) of between about 1×10⁴ and 5×10⁶ W/cm², or between about 1.6×10⁴ and 2.5×10⁶ W/cm².

The irradiance may be infrared (or near infrared) irradiance.

The particles may be nanoparticles, microparticles or bulk materials. In some embodiments the particles are nanocrystals or microcystals.

The particles may have an increased or enriched activator concentration. The particles may have an activator concentration of at least about 0.5 mol %, or at least about 1 mol %, or at least about 2 mol %, or at least about 3 mol %, or at least about 4 mol %, or at least about 5 mol %, or at least about 6 mol %, or at least about 7 mol %, or at least about 8 mol %, or at least about 10 mol %, or at least about 12 mol %, or at least about 14 mol %, or at least about 16 mol %, or at least about 18 mol % or at least about 20 mol %.

The activator may be Er³⁺, Tm³⁺, Sm³⁺, Dy³⁺, Ho⁺, Eu³⁺, Tb⁺, Pr³⁺ or any other rare-earth metal ion, including combinations thereof. In one embodiment the activator is Tm³⁺.

The particles may have an increased or enriched sensitiser concentration. The particles may have a sensitiser concentration in the range of about 10 mol % to about 95 mol %, or about 20 mol % to 90 mol %, or about 20 mol % to 80 mol %, or about 30 mol % to 80 mol %, or about 40 mol % to 80 mol %, or about 20 mol % to 40 mol %. In various embodiments the sensitiser is Yb³⁺, Nd³⁺ or Gd³⁺, or a combination thereof.

In the case of a quencher-free system, the concentration level of sensitizers can be increased from the currently used level of 20% to 30% or above, 40% or above, 50% or above, 60% or above, 70% or above, 80% or above, 90% or above.

Where the sensitiser is Yb³⁺ and the activator is Tm³⁺, the method may comprise subjecting the particles to an irradiance which is sufficient to cause at least partial population of the ³H₄ energy level and/or higher energy levels including the ¹G₄ and ¹D₂ energy levels of the Tm³⁺.

The host material may be, or may comprise, a lanthanide based material, an alkali fluoride, such as for example, NaYF₄, NaLuF₄, LiLuF₄, or KMnF₃ or an oxide, such as for example Y₂O₃, or oxysulfide, such as Gd₂O₂S.

In one embodiment, there is provided a method for enhancing upconversion luminescence of rare-earth doped particles comprising a host material, a sensitiser and an activator, wherein the particles have an activator concentration of at least about 1 mol %, and the method comprising subjecting the particles to an irradiance of at least about 10³ W/cm².

In another embodiment, there is provided a method for enhancing upconversion is luminescence of rare-earth doped particles comprising a host material, a sensitiser and an activator, wherein the particles have an activator concentration between about 1 mol % and 15 mol %, or between about 2 mol % and 10 mol %, the method comprising subjecting the particles to an irradiance of at least about 10³ W/cm², at least about 10⁴ W/cm², or at least about 10⁵ W/cm².

In another embodiment, there is provided a method for enhancing upconversion luminescence of rare-earth doped particles comprising a host material, a sensitiser and an activator, wherein the particles have an activator concentration between about 1 mol % and 20 mol %, or between about 2 mol % and 10 mol %, the method comprising subjecting the particles to an irradiance of at least about 10⁶ W/cm².

In another embodiment, there is provided a method for enhancing upconversion luminescence of rare-earth doped particles comprising a host material, a sensitiser which is Yb³⁺ present in a concentration between about 10 mol % and 99 mol %, or between about 20 mol % and 80 mol %, and an activator which is Tm³⁺ present in a concentration between about 1 mol % and 20 mol %, or between about 1 mol % and 10 mol %, the method comprising subjecting the particles to an irradiance of at least about 10⁵ W/cm², or at least about 10⁶ W/cm².

In another embodiment, there is provided a method for enhancing upconversion luminescence of rare-earth doped particles comprising a host material, a sensitiser which is Yb³⁺ present in a concentration between about 20 mol % and 60 mol %, or between about 20 mol % and 40 mol %, and an activator which is Tm³⁺ present in a concentration between about 1 mol % and 20 mol %, or between about 4 mol % and 10 mol %, the method comprising subjecting the particles to an irradiance of at least about 10⁶ W/cm².

In another embodiment, there is provided a method for enhancing upconversion luminescence of rare-earth doped particles comprising a host material, a sensitiser which is Yb³⁺ present in a concentration between about 20 mol % and 50 mol %, or between about 20 mol % and 40 mol %, and an activator which is Tm³⁺ present in a concentration between about 1 mol % and 20 mol %; or between about 2 mol % and 10 mol %, the method comprising subjecting the particles to an irradiance of at least about 10⁵ W/cm², or at least about 10⁶ W/cm².

In a second aspect, the present invention provides a system comprising rare-earth doped particles comprising a host material, a sensitiser and an activator, and a source of irradiance for subjecting the particles to increased irradiance or a minimum level of irradiance.

In another embodiment, there is provided a system for enhancing upconversion luminescence comprising: rare-earth doped particles comprising a host material, a sensitiser and an activator, wherein the particles have an activator concentration of at least about 1 mol %; and a source of irradiance for subjecting the particles to an irradiance of at least about 10³ W/cm².

The particles may be as defined in the first aspect.

The particles may be subjected to increased irradiance by, and/or in accordance with, the methods of the first aspect.

In a third aspect, the present invention provides rare-earth doped particles comprising a host material, a sensitiser and an activator, wherein the sensitiser is present in a concentration of at least about 20 mol %, and wherein the activator is present in a concentration of at least about 1 mol %.

The host material, activator and sensitiser may be as defined in the first aspect.

In some embodiments the sensitiser is Yb³⁺ and the activator is Tm³⁺.

The particles may be nanoparticles, microparticles or bulk materials. In some embodiments the particles are nanocrystals, microcrystals or bulk crystals.

In some embodiments, the sensitiser is present in a concentration of at least about 25 mol %, or at least about 30 mol %, or at least about 40 mol %, or at least about 50 mol %, or at least about 60 mol %, or at least about 70 mol %, or at least about 80 mol %, or at least about 90 mol %, and/or the activator is present in a concentration of at least about 4 mol %, at least about 5 mol %, at least about 10 mol %, at least about 15 mol %, at least about 20 mol %, at least. about 25 mol %, or at least about 30 mol %. Any combinations of the above noted concentrations are contemplated.

The following statements apply to the first, second and third aspects.

The particles may be present in a fibre, for example a suspended-core fibre.

The method, system and particles may find use in detection, sensing, imaging, flow cytometry, photo-dynamic therapy, nanomedicines, solar cell or display applications, fibre amplifier and optical communication, or security printings.

The sensing application may be, for example, a fibre sensing method, such as a fibre dip sensing method. Display applications include TV's and monitors. Nanomedicine applications include drug-carriers and drug-release activators.

In a fourth aspect, the present invention provides a system for capturing upconversion luminescence comprising: a suspended-core optical fibre comprising particles, the particles comprising a host material, an activator and a sensitiser, a laser beam for exciting the particles to produce upconversion luminescence, and a spectrometer for capturing the luminescence.

In another embodiment, there is provided a system for capturing or observing upconversion luminescence comprising: a suspended-core optical fibre including rare-earth doped particles, the particles comprising a host material, a sensitiser and an activator, wherein the particles have an activator concentration of at least about 1 mol %; at least one laser beam as a source of irradiance for subjecting the particles to an irradiance of at least about 10³ W/cm², thereby exciting the particles to produce upconversion luminescence; and a spectrometer for capturing or observing the luminescence.

The particles may be as defined in the first, second or third aspects.

### DESCRIPTION OF THE FIGURES

A preferred embodiment of the present invention will now be described, by way of example only, with reference to the accompanying drawings wherein:

FIG. 1 shows highly Tm³⁺-doped NaYF₄ nanocrystals exhibit enhanced upconversion in a suspended-core fibre. (a) Transmission electron microscopy images of monodispersed NaYF₄:Yb/Tm nanocrystals at different doping levels. Nanoparticles have a similar average size with a narrow size distribution. (b) Schematic of an example system configuration for capturing upconversion luminescence of NaYF₄:Yb/Tm nanocrystals using a suspended-core microstructured optical-fibre dip sensor. A continuous-wave 980-nm diode laser is targeted at the suspended core. Light propagates along the length of the fibre and interacts with the upconversion nanocrystals located within the surrounding s holes. The excited upconversion luminescence is coupled into the fibre core and the backward-propagating light is captured by a spectrometer. Inset: scanning electron microscope images showing a cross-section of the F2 suspended-core microstructured optical fibre at different magnifications. The fibre outer diameter is 160 μm with a 17 μm hole and 1.43 μm core. (c) Upconversion spectra of a series of NaYF₄:Yb/Tm nanocrystals with varied Tm³⁺ concentrations under an excitation irradiance of 2.5×10⁶ Wcm⁻², showing a steady increase in upconversion luminescence with increasing Tm³⁺ content from 0.2 mol % to 8 mol %.

FIG. 2 shows analysis of power-dependent multiphoton upconversion. (a) Simplified energy-level scheme of NaYF₄:Yb/Tm nanocrystals indicating major upconversion processes. Dashed lines indicate non-radiative energy transfer, and curved arrows indicate multiphonon relaxation. (b) Typical example evolution of spectra for 1 mol % Tm³⁺ as a function of excitation, showing substantial growth of emissions from the ¹G₄ and ¹D₂ levels with increasing excitation from 1×10⁴ Wcm⁻² to 2.5×10⁶ W cm⁻². (c)

Decomposition of the spectra into individual Gaussian peaks. Integrated intensities are given by I_{λ} where λ is the peak wavelength. Different transitions are indicated in the energy-level scheme (a). For example, the shaded area represents the ³H₄_{_{—}}→³H₆ transitions. (d) Intensity ratios of the ¹D₂ to ³H₄ classes (I₄₅₅+I₅₁₄+I₇₄₄+I₇₈₂)/I₈₀₂ and ¹G₄ to ³H₄ classes (I₄₈₀+I₆₆₀)/I₈₀₂ as a function of excitation irradiance. (e) Diagram illustrating energy transfer between the ensemble of Yb³⁺ and Tm³⁺ ions and subsequent radiative and non-radiative pathways. Top (bottom) panels: low (high) Tm³⁺/Yb³⁺ ratio. In the case of a low Tm³⁺/Yb³⁺ ratio, the limited number of Tm³⁺ ions creates an energy transfer bottleneck, due to the limited capacity of Tm³⁺ to release energy from the ³F₄ and ³H₄ states. Thus, at increasing excitation, alternative energy loss channels (radiative and non-radiative) involving higher states ¹G₄ and ¹D₂ progressively switch on.

FIG. 3 shows analysis of power-dependent upconversion efficiency. (a) Integrated upconversion luminescence intensity (˜400-850 nm) as a function of excitation irradiance for a series of Tm³⁺-doped nanocrystals. All samples have the same volume and number of nanocrystals. (b) As in (a) but divided by the concentration of Tm³⁺ ions. Under an excitation irradiance of 2.5×10⁶ Wcm⁻², 2 mol % Tm³⁺ has the highest relative upconversion efficiency, whereas the strongest upconversion signal is observed in 8 mol % Tm³⁺ due to the larger number of activators available with sufficient excitation.

FIG. 4 shows detection of a single nanocrystal in a suspended-core microstructured fibre dip sensor. (a) Results of 10 trials of loading 3.9 fM nanocrystal solution into the fibre dip sensor. Four positive trials, show comparable ˜800 to 810 nm emission peaks, and six trials result in consistent background noise baselines. The baseline level is due to scattering of 980 nm excitation. (b) Normalized nanocrystal emission integrated from ˜800 to 810 nm. The four positive trials produce intensities of ˜250 with a low coefficient of variation (CV) of 4.7%, and high signal-to-noise ratio of >8. (c) Time-dependent dynamics of three independent trials. Circles: trial with no nanocrystals observed (only background is observed). Triangles: one nanocrystal appears shortly after the start of the trial. Squares: single- nanocrystal appears in the fibre after 2 min, followed by a second at ˜5 min; one of the nanocrystals then exits the observation volume.

FIG. 5 shows comparison of upconversion spectra of the as-synthesised NaYF4: Yb/Tm nanocrystals with different Tm³⁺ concentrations excited at a low irradiance level of 10 W/cm². (a) The spectra at various Tm³⁺ concentrations. At 10 W/cm² irradiance, the 0.5 mol % Tm³⁺ doped nanocrystals emit the brightest upconversion luminescence. (b) The evolution of emission intensity of various upconversion peaks as a function of Tm³⁺ concentration. (c) Selected powder XRD patterns of the example as-synthesized NaYF4: Yb/Tm nanocrystals doped with various concentrations of Tm³⁺ ions. The diffraction peaks are indexed according to the standard XRD pattern of hexagonal-phase NaYF₄ (Joint Committee on Powder Diffraction Standards file number 28-1192), confirming that all the samples have hexagonal phase.

FIG. 6 shows the weight of upconversion luminescence intensity as a function of excitation power density for examples of 0.5 mol %, 4 mol % and 8 mol % Tm³⁺. All spectra have been normalised at the 802 nm, top spectra: 10 W/cm², middle spectra: 1.6×10⁴ W/cm² and bottom spectra: 2.5×10⁶ W/cm² for 0.5 mol %, 4 mol % and 8 mol % Tm³⁺, correspondingly. It is noted note that at low irradiance excitation of 10 W/cm² the process of two-photon upconversion dominates making up 67% of the luminescence intensity. With increasing excitation powers, the three- and four-photon excitation processes become more pronounced. These eventually dominate at the maximum excitation, with the two-photon process contributing only 13%. Conversely, for 4 mol % and 8 mol % high-doped Tm³⁺ nanocrystals, the spectrum is dominated by two-photon upconversion over most of the excitation power range. The contribution of two-photon upconversion varies from 94% to 47% in 4% Tm, and from 99% to 42% in 8% Tm between 1:6×10⁴ W/cm² and 2.5×10⁶ W/cm², thus the higher order processes make a smaller contribution compared with the 0.5 mol % Tm³⁺ sample. In all samples the two-photon upconversion first increases very rapidly and then reaches a plateau, typical of fluorescence saturation. The 0.5 mol % Tm³⁺ sample is the first to approach saturation (below 1.6×10⁴ W/cm²) because low Tm³⁺ content limits the total decay rate of two-photon upconversion. The 4 mol % and 8 mol % Tm³⁺ sample saturate at higher excitation powers, above 1.6×10⁴ W/cm². This is confirmed by the fact that in these nanocrystals the two-photon upconversion constitutes above 90% of total luminescence for excitation irradiance up to 1.6×10⁴ W/cm². Also shown is the integrated upconversion luminescence intensity as a function of excitation power density for 0.5 mol %, 4 mol % and 8 mol % Tm³⁺.

FIG. 7 represents a power-dependent guide to optimal material choice for example blue emissions and infrared emissions.

FIG. 8 shows examples for the upconversion emission intensity at seven major wavelengths vs. Tm³⁺ doping concentrations from 0.2 mol % to 8 mol %. a) and c) by excitation irradiance of 0.22×10⁶ W/cm², b) and d) by excitation intensity of 2.5×10⁶ W/cm².

FIG. 9 is an example block diagram setting out the steps for capturing upconversion luminescence in accordance with an embodiment of the invention.

FIG. 10 shows an example crystal comprising a sensitiser, quencher, relay activator and inactive ions as host material. Because an intermediate meta stable energy level of the activator exists above, or equal to the sensitiser excited state level sensitized photons are able to travel freely through the crystal due to back energy transfer.

Accordingly, the sensitized photons travel rapidly over large distances within the crystal, thereby significantly increasing the probability of encountering quenchers.

FIG. 11 shows an example crystal comprising a sensitiser, quencher, trap activator and inactive ions as the host material. On meeting the activator, sensitised photons are retained (or “trapped”) and receive secondary photons which drive upconversion emissions because a meta stable energy level of the activator exists below the sensitiser excited state level so that back energy transfer is minimised. Because such photons travel only a very short distance within the particle (i.e. from a sensitiser to an activator—depicted by the converging arrows), the chance of encountering a quencher is minimised.

FIG. 12 shows an example crystal comprising a core comprising a sensitiser, a trap activator and/or a relay activator and inactive ions as the host material. A protective shell including a quencher can be provided. Regardless of whether back energy transfer occurs, the probability of sensitized photons encountering surface quenchers is substantially reduced.

FIG. 13 shows simplified energy diagrams illustrating an example novel depletion strategy in upconversion nanocrystals (B) compared to a conventional fluorescence strategy to achieve stimulated emission depletion (A).

FIG. 14 shows example depletion characteristics for a standard biolabel Dylight 650 depleted at 750 nm, low concentration (0.5 mol %) and high concentration (6 mol %) upconversion nanocrystals depleted at 808 nm. For lateral resolution of 70 nm Dylight 650 requires a depletion-irradiance of 10⁸ W/cm². The highly-doped (6 mol %) Tm³⁺ nanocrystals surprisingly reduce the depletion power requirement by more than three orders of magnitudes.

FIG. 15 shows an example of STimulated Emission Depletion (STED) based on use of upconversion particles/nanocrystals, providing a technique for achieving super-resolution in optical microscopy beyond the theoretical Abbe diffraction limit at low power. An example 808 nm doughnut-shaped laser beam is used to trim the primary excitation (980 nm) focus by “switching off” the surrounding excited upconversion biolabels through a stimulated emission pathway (“de-excitation”). The spatial resolution achieved in STED microscopy is strongly dependent on the intensity of the depletion-laser beam. The scale bar is 1μm.

FIG. 16 shows an example application for security inks. Images for the “University of Adelaide” and the Sydney harbour bridge were printed using mask ink having 0.2 mol % Tm upconversion nanocrystals, and images for “Macquarie University” and the fireworks about the Sydney harbour bridge were printed using a security ink having 4 mol % Tm upconversion nanocrystals. The low power excitation was about 10⁴ W/cm², the high power excitation was about 10⁶ W/cm².

FIG. 17 shows example power dependent single bulk crystal measurements under wide-field upconversion luminescence microscope. Figures a) and b) are TEM images of as-prepared bulk crystals at Tm³⁺ doping concentration of 8 mol % and 2 mol % respectively; c) and d) are luminescence images in the visible range (400˜700 nm) at excitation power density of 0.1×10⁶ W/cm², and e) and f) are taken at higher excitation of 5×10⁶ W/cm² for 8 mol % Tm³⁺ and 2 mol % Tm³⁺ single bulk crystals, respectively. All the luminescence images are produced at the same CCD exposure time of 60 milliseconds. g) shows power-dependent intensities (integrated over 400˜850 nm range) of the same single bulk crystals measured by a single-photon counting avalanche diode (SPAD).

### Definitions

The following are some definitions that may be helpful in understanding the description of the present invention. These are intended as general definitions and should in no way limit the scope of the present invention to those terms alone, but are put forth for a better understanding of the following description.

Throughout this specification and the claims which follow, unless the context requires otherwise, the word “comprise”, and variations such as “comprised”, “comprises” or “comprising”, will be understood to imply the inclusion of a stated integer or step or group of integers or steps but not the exclusion of any other integer or step or group of integers or steps.

The articles “a” and “an” are used herein to refer to one or to more than one (i.e. to at least one) of the grammatical object of the article. By way of example, “an element” means one element or more than one element.

In the context of this specification, the term “about” is understood to refer to a range of numbers that a person of skill in the art would consider equivalent to the recited value in the context of achieving the same function or result.

In the context of this specification, the terms “rare-earth”, “rare-earth metal”, “rare-earth element” and the like are understood to refer to the following elements and ions thereof: Lanthanum, Cerium, Praseodymium, Neodymium, Promethium, Samarium, Europium, Gadolinium, Terbium, Dysprosium, Holmium, Erbium, Thulium, Ytterbium, Lutetium, Scandium and Yttrium. The ions may be present in the +3 oxidation state, or other oxidation states.

In the context of this specification, the term “sensitiser” is understood to mean an entity that absorbs energy (such as infrared energy) and transfers this energy non-radiatively to the activator.

In the context of this specification, the term “activator” (i.e. emitter) is understood to mean an entity which receives energy from the sensitiser and as a consequence thereof emits upconversion luminescence.

### DETAILED DESCRIPTION OF THE INVENTION

The present inventors have developed an understanding of the factors that contribute to concentration quenching in rare-earth doped particles, and developed methods, systems and particles which enable concentration quenching to be minimised or avoided such that increased activator and sensitiser concentrations may be utilised to optimise luminescence intensity/brightness.

Concentration quenching occurs as a result of the following phenomena. 1) A lack of available sensitised photons per activator ion which inactivates the upconversion luminescence process because statistically most of the activator ions remain in a lower “dark” energy level. 2) Back energy transfer occurring between excited activator ions and sensitiser ions which leads to photons travelling efficiently between sensitiser ions and activator ions thereby rapidly encountering quenchers located at the crystal surface or within the crystal lattice (i.e. crystal defects, this typically happens in high phonon-energy host materials such as glass, or high quenching crystal host, such as the cubic-phase crystals, therefore hexagonal phase fluoride crystals are typically the best host materials). 3) The increased occurrence of sensitised photons encountering quenchers located at the crystal surface or within the crystal lattice at high sensitiser concentrations (for example above 30 mol %). The contribution of these phenomena results in the activator concentration, or the activator and sensitiser concentration, “quenching” upconversion luminescence at relatively low irradiation power.

It has been discovered by the present inventors that upconversion luminescence, by way of example specifically in NaYF₄:Yb/Tm nanocrystals, can be significantly enhanced at increased activator concentrations by subjecting the nanocrystals to increased irradiance.

The inventors have surprisingly found that high excitation irradiance can alleviate concentration quenching in upconversion luminescence when combined with higher activator concentration. For example, this allows activator concentration to be increased well above the known level of 0.5 mol % Tm³⁺ in NaYF₄. This leads to significantly enhanced luminescence signals, in one example by up to a factor of about seventy. By using such bright nanocrystals, remote tracking of a single nanocrystal can be achieved, as demonstrated with a microstructured optical-fibre dip sensor by way of illustrative example. This achievement represents a sensitivity improvement of three orders of magnitude over benchmark nanocrystals such as quantum dots.

Without wishing to be bound by theory the inventors postulate that in the case of NaYF₄:Yb/Tm nanocrystals elevated irradiance using a 980 nm diode laser beam induces neighbouring Yb³⁺ sensitisers to transfer sufficient excitation to Tm³⁺ activators so that each Tm³⁺ ion receives at least two sequential 980 nm photons. At increased activator concentrations the additional photons sequentially pump the increased Tm³⁺ present from the ³F₄ level (dark state) to the ³H₄ energy level or higher energy levels, including the ¹G₄ and ¹D₂ levels (visible luminescent states). In addition, back energy transfer from excited Tm³⁺ ions to Yb³⁺ sensitisers is avoided because Tm³⁺ has an intermediate meta stable energy level below the excited state level of Yb³⁺. Concentration quenching is therefore reversed leading to significantly enhanced upconversion luminescence by virtue of both increased activator concentration and accelerated sensitiser-activator energy transfer rate as a result of a decreased average minimum distance between the sensitisers and activators.

By virtue of overcoming the phenomenon of concentration quenching the present invention enables the use of increased activator and sensitiser concentrations to optimise luminescence intensity/brightness.

As described herein the inventors have observed that at an irradiance power of 2.5×10⁶ W/cm² nanocrystals comprising 8 mol % Tm³⁺ resulted in an increase in the integrated upconversion signal by a factor of 1105 compared to the integrated upconversion signal at an irradiance power of 1.6×10⁴ W/cm². Conveniently, excitation irradiance powers in the range of 10⁴ to 10⁶ W/cm² are within the normal operating range of various microscopes. In this regard, 10⁴ W/cm² corresponds to 1 mW over a 10 μm² cross-sectional area, which is achievable in wide-field microscopy illumination, while 10⁵ W/cm² corresponds to 1 mW in a 1 μm² cross-sectional area, which is consistent with laser scanning confocal microscopy.

In one embodiment there is provided a method for enhancing upconversion luminescence of rare-earth doped particles comprising a host material, an enriched concentration of sensitiser and a sufficient concentration level of activator, the method comprising subjecting the particles to increased irradiance or a minimum level of irradiance. The increased or minimum level of irradiance is higher than presently used relatively low irradiance levels. Enhancing upconversion luminescence involves enhancing luminescence intensity and/or brightness and/or upconversion efficiency. The particles are preferably subjected to an irradiance power density which is sufficient to overcome or reverse concentration quenching of upconversion luminescence. The activator preferably has an intermediate meta stable energy level which exists accepting resonance energy from the sensitiser excited state level. In another form, the particles are configured to or designed to reduce, minimize or exclude one or more quenchers from the upconversion system between the sensitizer and the activator. For example, a core-shell particle or system can be provided wherein the core comprises the host material, sensitiser and the activator, and the shell comprises a material which prevents, retards or inhibits surface quenching.

In one embodiment, the particles are subjected to an irradiance, i.e. an increased irradiance or a minimum level of irradiance, which is sufficient to overcome or reverse concentration quenching of upconversion luminescence. In another embodiment, the particles are subjected to an irradiance which is sufficient to cause population of an upconversion energy state of the activator.

In alternative embodiments, where the sensitiser is Yb³⁺and where the activator is Tm³⁺ the particles may be subjected to an irradiance which is sufficient to cause population of the ³H₄ energy level and/or higher energy levels including the ¹G₄ and ¹D₂ energy levels, of Tm³⁺.

In other embodiments, the particles may be subjected to an irradiance (i.e. an increased irradiance or a minimum level of irradiance) of at least about 10² W/cm², or at least about 10³ W/cm², or at least about 10⁴ W/cm², or at least about 10⁵ W/cm², or at least about 10⁶ W/cm², or at least about 10⁷ W/cm², or at least about 10⁸ W/cm², or at least about 10⁹ W/cm², or at least about 10¹⁰ W/cm². In some embodiments, the particles may be subjected to an irradiance of at least about 1.6×10⁴ W/cm², or an irradiance between about 1.0×10⁴ W/cm² and 5.0×10⁶ W/cm², or an irradiance between about 1.6×10⁴ W/cm² and 2.5×10⁶ W/cm², or an irradiance of about 2.5×10⁶ W/cm².

Based on the information herein, those skilled in the art will be able to select an appropriate irradiance value for a given activator concentration so as to overcome or reverse concentration quenching. Likewise, those skilled in the art will be able to select an appropriate activator concentration for a given irradiance value so as to overcome or reverse concentration quenching.

The particles described herein are comprised of an inert host material doped with sensitiser(s) and activator(s), and may be referred to as “upconversion particles”, “upconversion nanoparticles” or “upconversion nanocrystals”. The sensitiser and the activator are typically in the form of ions (for example but not necessarily the 3+ oxidation state), and may comprise combinations of different activators and/or combinations of different sensitisers. At least one of the sensitiser(s) and activator(s) is a rare-earth metal, and hence the particles are referred to herein as “rare-earth doped particles”. Typically, both the activator(s) and sensitiser(s) are rare-earth metals.

In various aspects, the activator may be present in a concentration of at least about 0.5 mol %, at least about 1 mol %, at least about 1.5 mol %, at least about 2 mol %, at least about 2.5 mol %, at least about 3 mol %, at least about 3.5 mol %, at least about 4 mol %, at least about 4.5 mol %, at least about 5 mol %, at least about 5.5 mol %, at least about 6 mol %, at least about 6.5 mol %, at least about 7 mol %, at least about 7.5 mol %, least about 8 mol %, at least about 10 mol %, at least about 12 mol %, at least about 14 mol %, at least about 16 mol %, at least about 18 mol %, or at least about 20 mol %.

In some embodiments the activator is present in a concentration between about 1 mol % and 30 mol %, or between about 1 mol % and 25 mol %, or between about 1 mol % and 20 mol %, or between about 1 mol % and 15 mol %, or between about 2 mol % and 30 mol %, or between about 2 mol % and 25 mol %, or between about 2 mol % and 20 mol %, or between about 2 mol % and 15 mol %, or between about 4 mol % and 30 mol %, or between about 4 mol % and 25 mol %, or between about 4 mol % and 20 mol %, or between about 4 mol % and 15 mol %, or between about 4 mol % and 8 mol %.

In other various aspects the activator may be present in a concentration of at least about 2 mol %, at least about 2.5 mol %, at least about 3 mol %, at least about 3.5 mol %, at least about 4 mol %, at least about 4.5 mol %, at least about 5 mol %, at least about 5.5 mol %, at least about 6 mol %, at least about 6.5 mol %, at least about 7 mol %, at least about 7.5 mol %, at least about 8 mol %, at least about 10 mol %, at least about 12 mol %, at least about 14 mol %, at least about 16 mol %, at least about 18 mol %, or at least about 20 mol %. In some embodiments the activator is present in a concentration between about 2 mol % and 30 mol %, or between about 2 mol % and 20 mol %, or between about 2 mol % and 15 mol %, or between about 2 mol % and 8 mol %, or between about 4 mol % and 8 mol %.

Activators that may be used in the particles will be well known to those skilled in the art and include any rare-earth metal ions and combinations thereof, for example Er³⁺, Tm³⁺, Ho³⁺, Dy³⁺, Eu³⁺, Tb³⁺, Sm³⁺ and Pr³⁺.

In other various aspects, the sensitiser may be present in a concentration between about 10 mol % and 95 mol %, or between about 15 mol % and 90 mol %, or between about 20 mol % and 90 mol %, or between about 25 mol % and 90 mol %, or between about 15 mol % and 30 mol %, or between about 15 mol % and 25 mol %, or about 20 mol %.

In other various aspects the sensitiser may be present in a concentration between about 20 mol % and 95 mol %, or between about 20 mol % and 80 mol %, or between about 30 mol % and 90 mol %, or between about 35 mol % and 90 mol %, or between about 40 mol % and 90 mol %, or between about 20 mol % and 40 mol %, or between about 50 mol % and 90 mol %, or between about 60 mol % and 90 mol %, or about 20 mol %, or about 40 mol %, or about 60 mol %, or about 80 mol %.

Suitable sensitisers include any rare-earth metal ions and combinations thereof. In one embodiment the sensitiser is Yb³⁺. In other embodiments the sensitiser could be Gd³⁺, Nd³⁺ or Ce³⁺, or combinations of the sensitisers. For example, the Nd³⁺ sensitiser can be used as a sensitizer to absorb 800 nm excitation, and the Gd³⁺ sensitiser can be a sensitizer to absorb UV excitation.

The ratio of the sensitiser to the activator may be between about 1:1 and 40:1, or between about 1:1 and 30:1, or between about 1:1 and 20:1, or between about 1:1 and 10:1, or between about 1:1 and 5:1, or between about 1:1 and 4:1, or between about 1:1 and 3:1.

In embodiments of the invention the particles may be nanoparticles or nanocrystals. In other embodiments of the invention the particles may be microparticles or microcrystals. In other embodiments of the invention the particles may be, or may form, a bulk material.

In some embodiments the particles may comprise increased or enriched amounts of activators and also sensitisers. For example, in various aspects the activator may be present in a concentration of at least about 0.5 mol %, at least about 1 mol %, at least about 1.5 mol %, at least about 2 mol %, at least about 2.5 mol %, at least about 3 mol %, at least about 3.5 mol %, at least about 4 mol %, at least about 4.5 mol %, at least about 5 mol %, or at least about 10 mol %, or at least about 12 mol %, or at least about 14 mol %, or at least about 16 mol %, or at least about 18 mol %, or at least about 20 mol %, or at least about 22 mol %, or at least about 24 mol %, or at least about 26 mol %, or at least about 28 mol %, or at least about 30 mol %, or at least about 35 mol %, or at least about 40 mol %, or at least about 45 mol % or at least about 50 mol %, and/or the sensitiser may be present in a concentration of at least about 20 mol %, or at least about 25 mol %, or at least about 30 mol %, or at least about 35 mol %, or at least about 40 mol %, or at least about 45 mol %, or at least about 50 mol %, or at least about 55 mol %, or at least about 60 mol %, or at least about 65 mol %, or at least about 70 mol %, or at least about 75 mol %, or at least about 80 mol %, or at least about 85 mol % or at least about 90 mol %. Any combinations of the above noted concentrations are contemplated.

In some embodiments the activator may be present in a concentration between about 1 mol % and 30 mol %, or between about 1 mol % and 25 mol %, or between about 1 mol % and 20 mol %, or between about 1 mol % and 15 mol %, or between about 2 mol % and 30 mol %, or between about 2 mol % and 25 mol %, or between about 2 mol % and 20 mol %, or between about 2 mol % and 15 mol %, or between about 4 mol % and 30 mol %, or between about 4 mol % and 25 mol %, or between about 4 mol % and 20 mol %, or between about 4 mol % and 15 mol %, or between about 4 mol % and 8 mol %, and/or the sensitiser may be present in a concentration between about 10 mol % and 95 mol %, or between about 15 mol % and 90 mol %, or between about 20 mol % and 90 mol %, or between about 25 mol % and 90 mol %, or between about 15 mol % and 30 mol %, or between about 15 mol % and 25 mol %, or about 20 mol %. Any combinations of the above noted concentrations are is contemplated.

In other various aspects, the activator may be present in a concentration of at least about 2 mol %, or at least about 6 mol %, or at least about 10 mol %, or at least about 15 mol %, or at least about 20 mol %, or at least about 25 mol %, or at least about 30 mol %, or at least about 35 mol %, or at least about 40 mol %, or at least about 45 mol %, or at least about 50 mol % or at least about 55 mol %, and/or the sensitiser may be present in a concentration of at least about 20 mol %, or at least about 25 mol %, or at least about 30 mol %, or at least about 35 mol %, or at least about 40 mol %, or at least about 45 mol %, or at least about 50 mol %, or at least about 55 mol %, or at least about 60 mol %, or at least about 65 mol %, or at least about 70 mol %, or at least about 75 mol %, or at least about 80 mol %, or at least about 85 mol % or at least about 90 mol %. Any combinations of the above noted concentrations are contemplated.

In other embodiments the activator is present in a concentration between about 2 mol % and 30 mol %, or between about 2 mol % and 15 mol %, or between about 2 mol % and 8 mol %, or between about 4 mol % and 8 mol %, and/or the sensitiser is present in a concentration between about 20 mol % and 95 mol %, or between about 20 mol % and 80 mol %, or between about 30 mol % and 90 mol %, or between about 35 mol % and 90 mol %, or between about 40 mol % and 90 mol %, or between about 20 mol % and 40 mol %, or between about 50 mol % and 90 mol %, or between about 60 mol % and 90 mol %, or about 20 mol %, or about 40 mol %, or about 60 mol %, or about 80 mol %. Any combinations of the above noted concentrations are contemplated.

Suitable host materials will be familiar to those skilled in the art and include any materials having a low phonon energy level and minimal internal quenchers. For example, the host material preferably has a phonon energy level below about 750 cm⁻¹, or below about 500 cm⁻¹, or below about 400 cm⁻¹, or below about 370 cm⁻¹.

Suitable host materials include, but are not limited to, alkali fluorides, such as NaGdF₄, NaYF₄, LiYF₄, NaLuF₄ and LiLuF₄, KMnF₃, and oxides, such as Y₂O₃. Mixtures of these materials are also contemplated. In one embodiment, the host material is NaYF₄. Where the particles are crystalline the NaYF₄ may be hexagonal phase, or any other crystal phase.

Once sensitised by the sensitiser, photons are primarily transferred to either activators or neighbouring sensitisers. Consequently, photons will either be transferred to an activator leading to upconversion and resultant luminescence emission, or alternatively encounter a quencher. In some examples, quenchers are populated primarily on the crystal surface due to the large surface to volume ratio, but also exist internally in the form of crystal defects which are dependent on phonon energy levels. Where the sensitiser concentration exceeds 30 mol % for example, the chance of sensitised photons encountering quenchers is significantly increased thereby contributing to concentration quenching. A further contribution to concentration quenching occurs via back energy transfer, which is possible when the activator has an excited meta stable state that is above, or equal to, the sensitiser excited state level (see FIG. 10). Accordingly, methods which reduce the activity of sensitised photons by either preventing back energy transfer or reducing access of photons to quenchers contribute to the minimisation of concentration quenching, thereby permitting high concentrations of sensitisers and activators to be employed in order to realise optimal luminescence intensity/brightness at higher irradiation powers. Embodiments include particles designed or configured to minimize the quenchers, including both surface quenchers and internal quenchers such as from crystal defects.

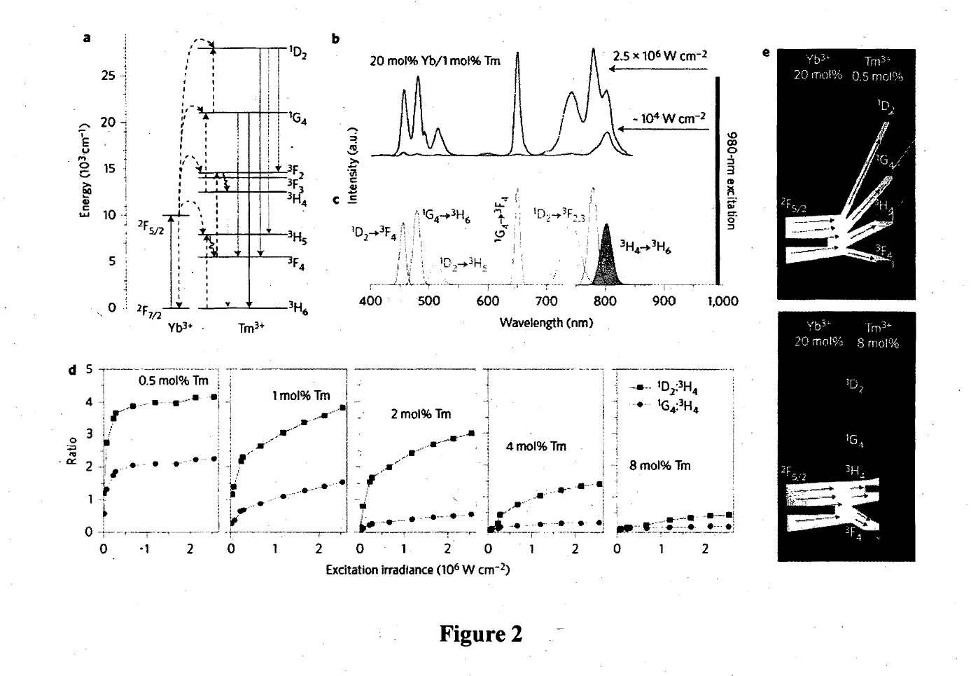

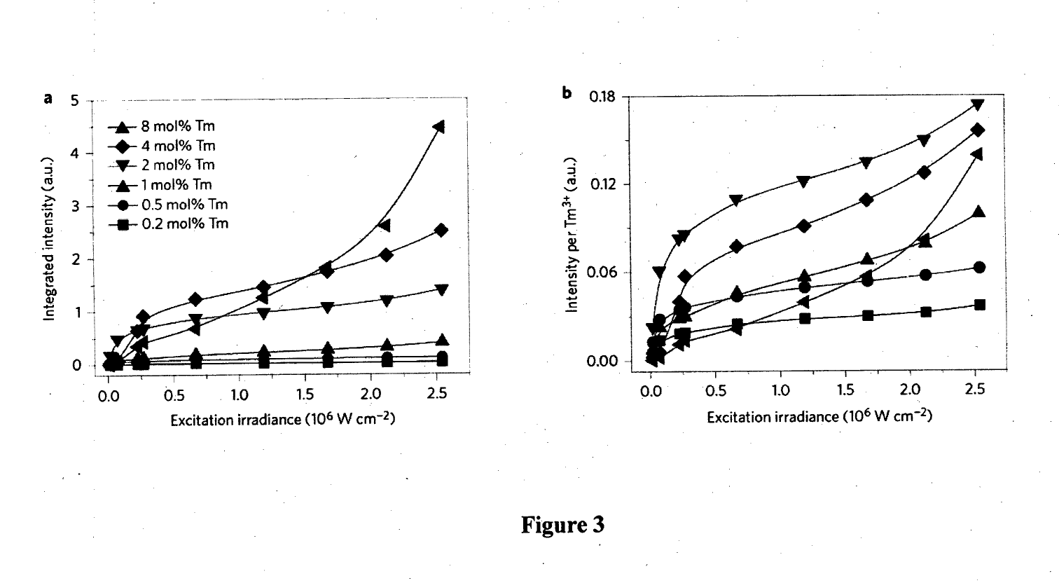

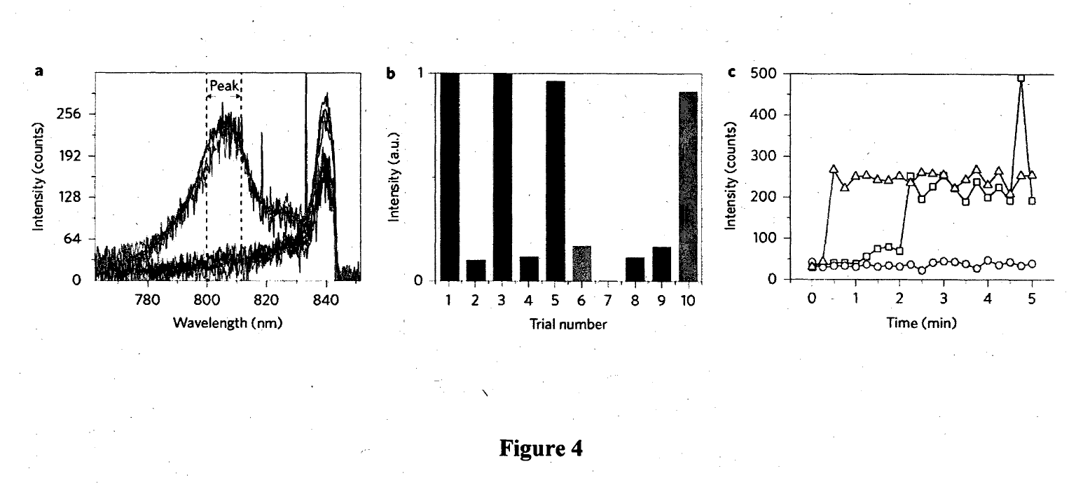

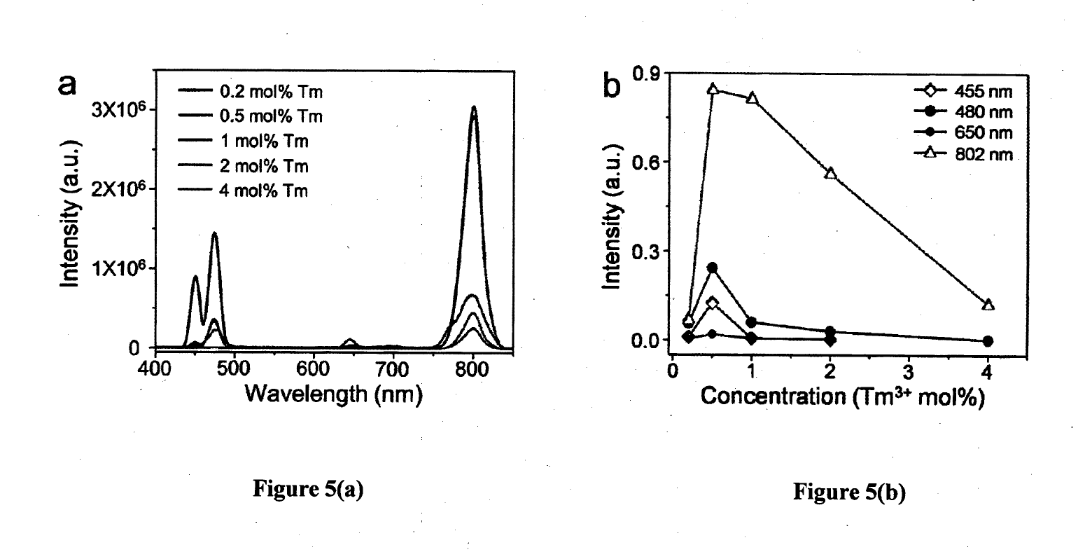

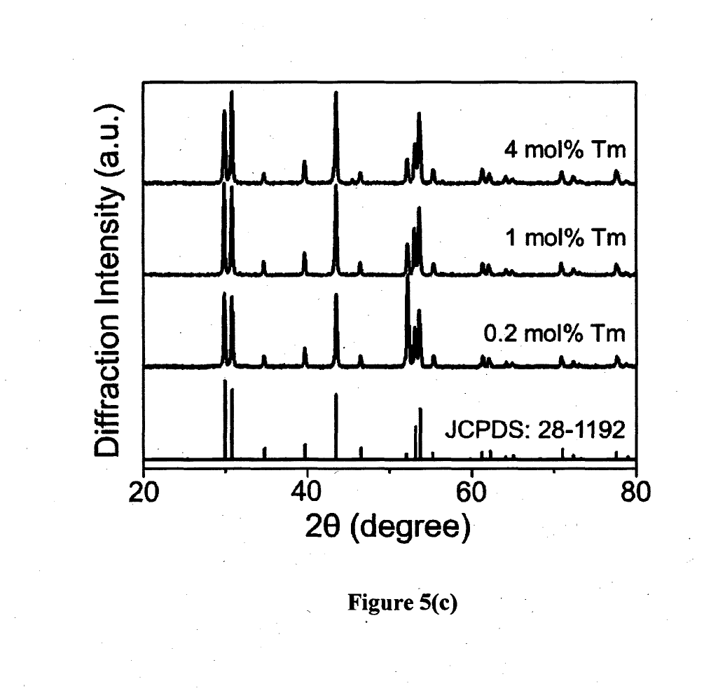

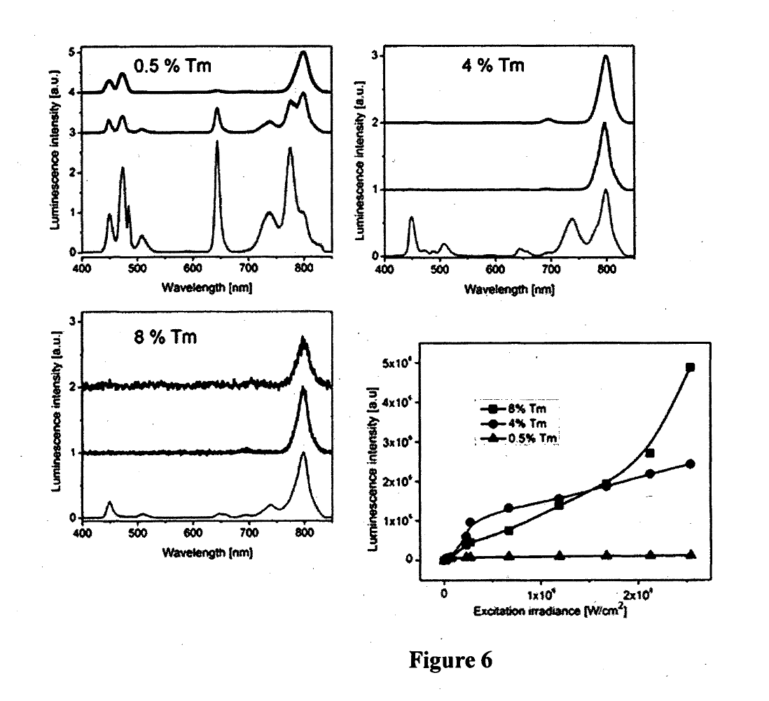

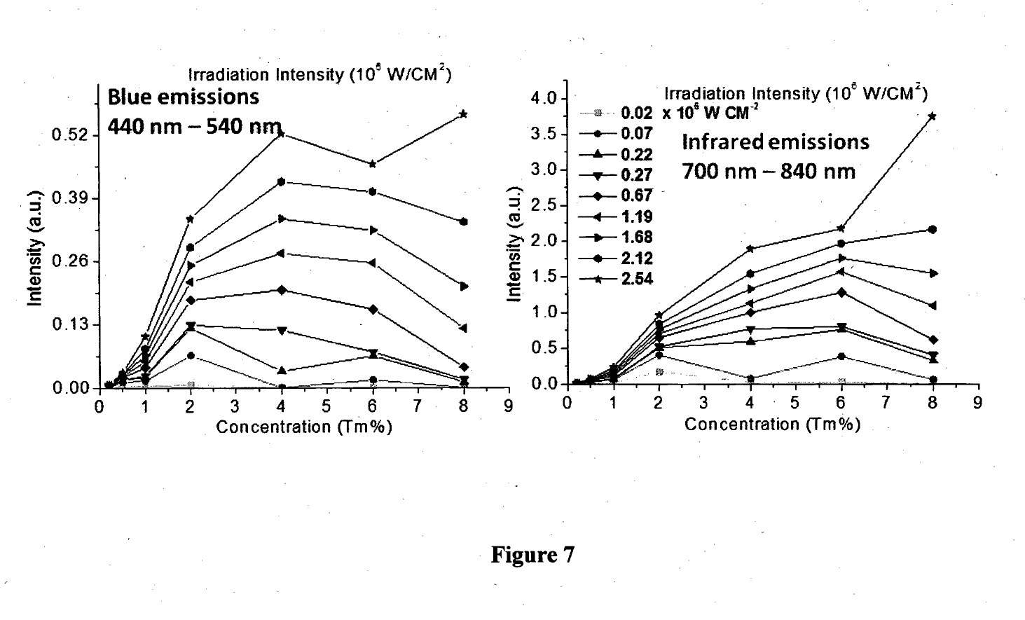

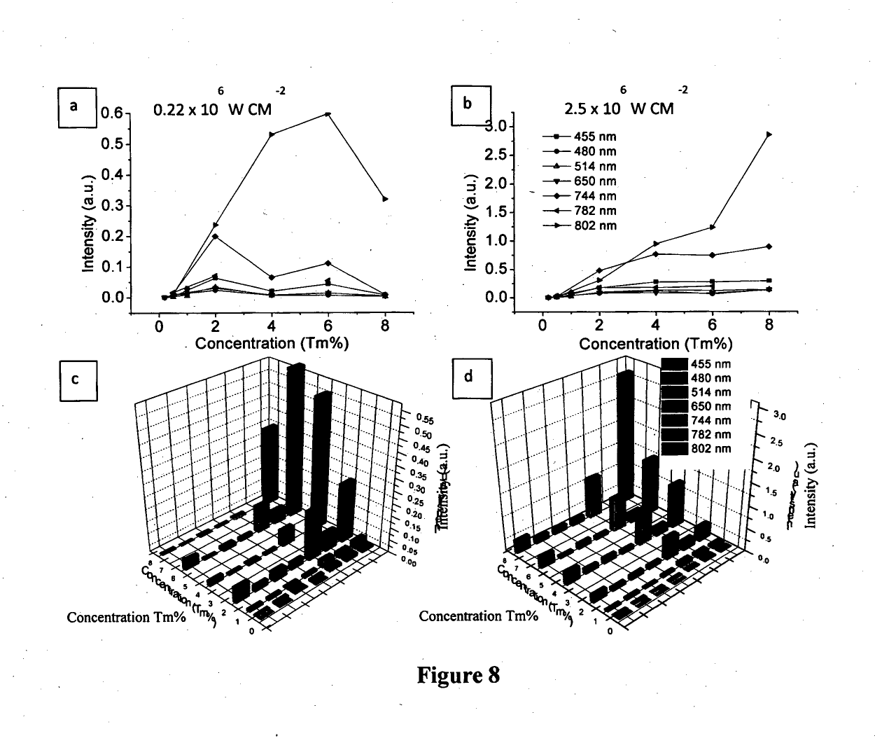

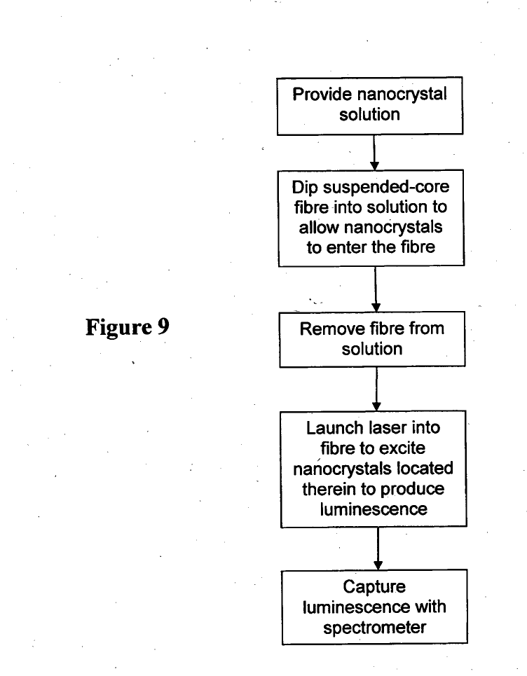

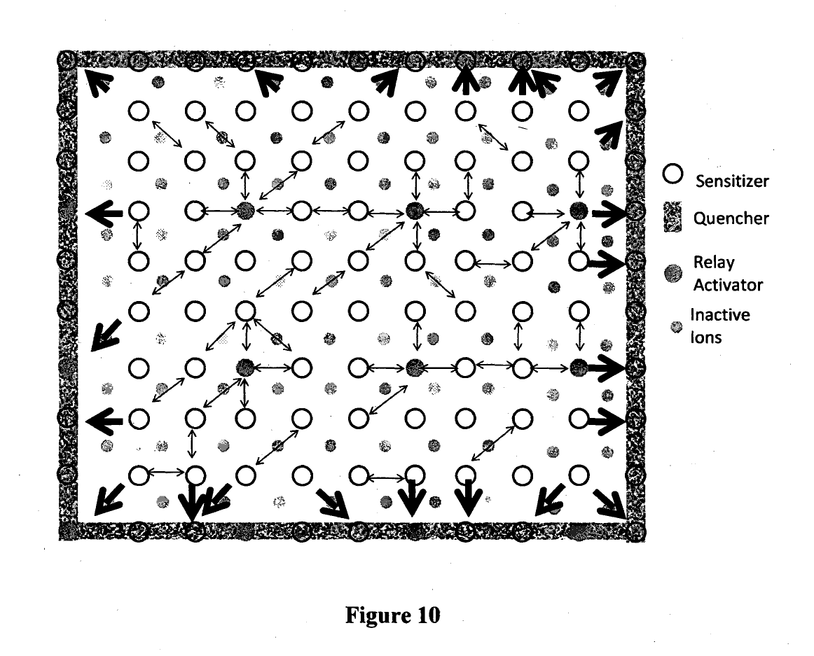

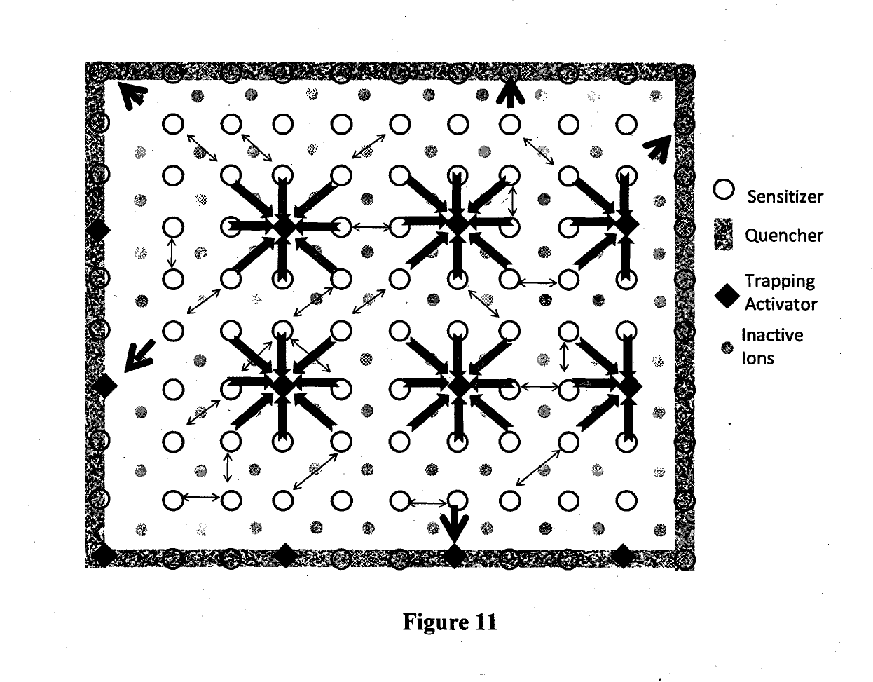

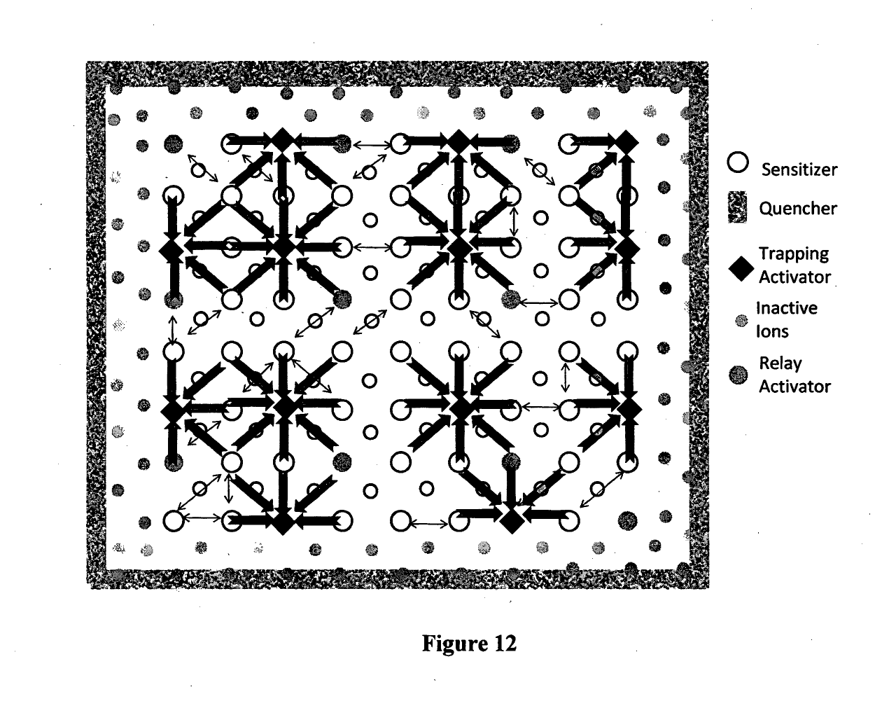

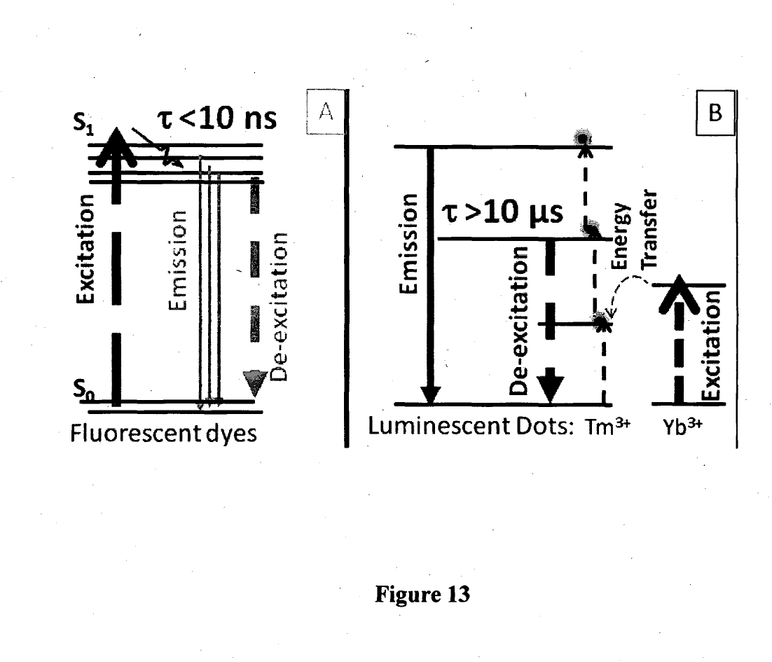

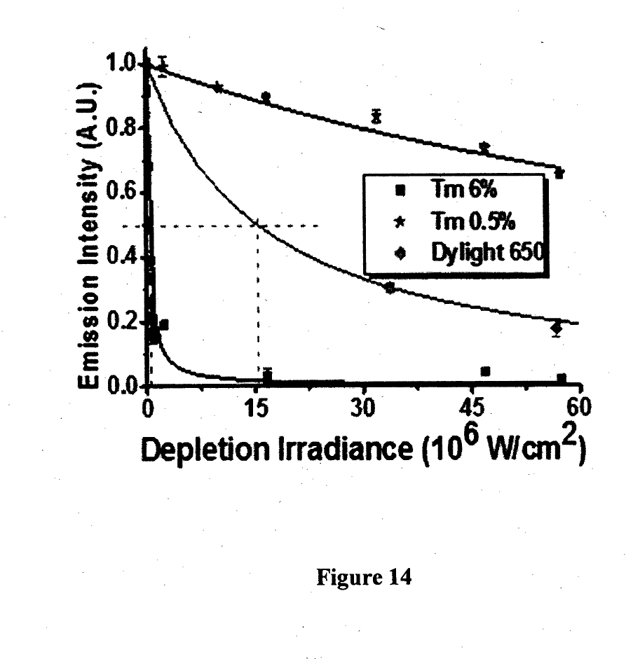

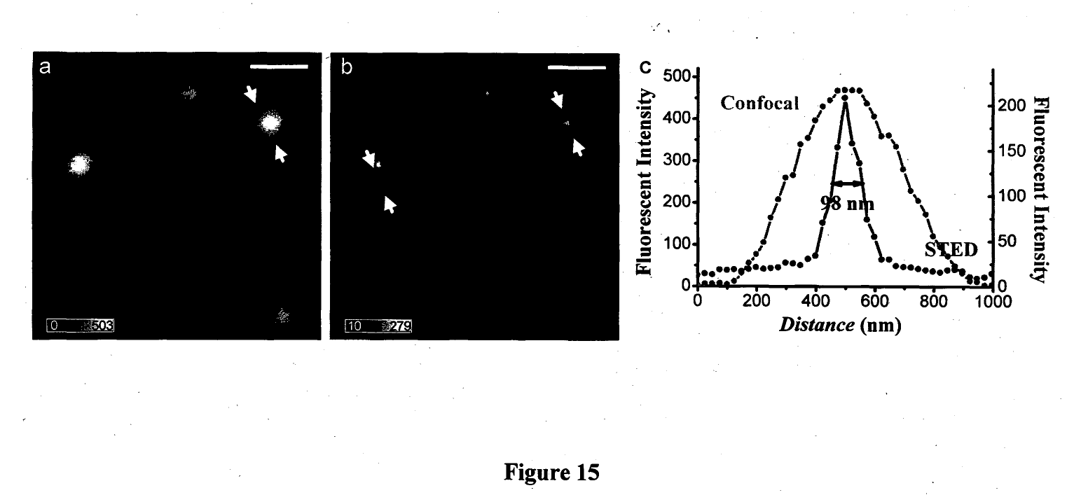

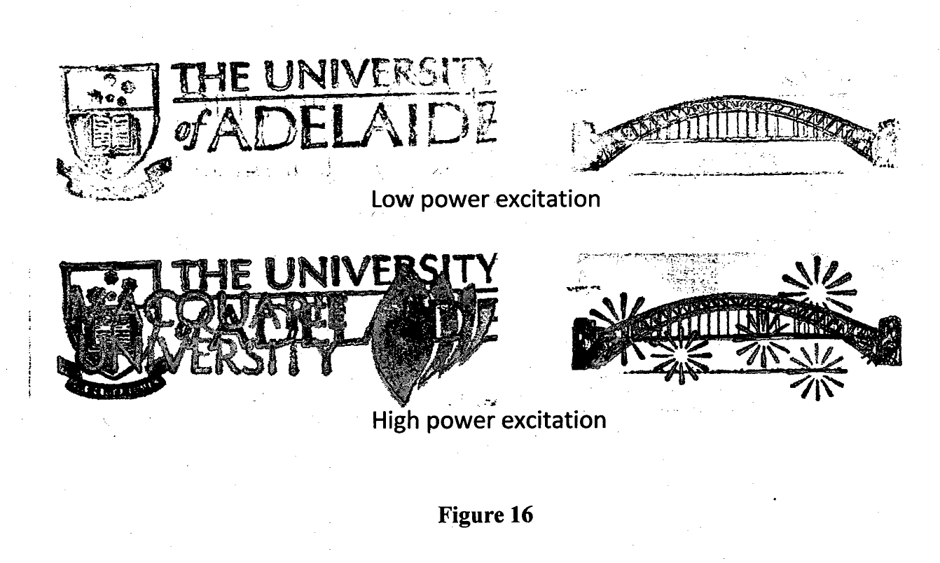

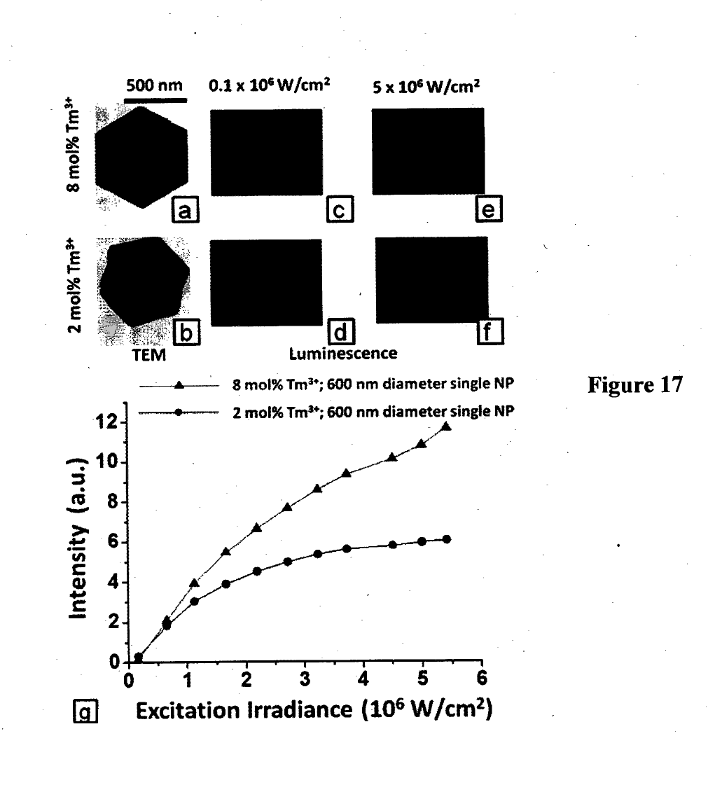

Accordingly, in one embodiment the combination of activator and sensitiser is chosen such that a meta stable energy level of the activator exists below the sensitiser excited state level so that back energy transfer from the activator to the sensitiser is minimised or prevented from occurring. Such activators may be referred to as “trap activators” in the sense that sensitised photons cannot undergo back energy transfer to the sensitiser, and are in effect “trapped” by the activator. Because such photons travel only within a limited space in the particle (i.e. from a sensitiser to an activator), the chance of encountering a quencher is minimised (see FIG. 11). Examples of activator/sensitiser combinations wherein a meta stable energy level of the activator exists below the sensitiser excited state level include Tm³⁺/Yb³⁺ and Ho³⁺/Yb³⁺. In the case of the Tm³⁺/Yb³⁺ combination, the ³F₄ energy level of Tm³⁺ is located below the excited state level of Yb³⁺ (see FIG. 2a).

In other embodiments the sensitiser, activator and host material are protected against surface quenchers by a shell, such that the particles are core-shell particles wherein the core comprises the activator, the sensitiser and the host material, and the shell comprises, or consists of, a material which prevents, retards or inhibits surface quenching. The shell may partially or completely encapsulate the core. Preferably, the shell comprises or consists of the same material as the host material, but without the rare-earth metal dopants. In the case of crystals, this avoids the need for phase matching.

The presence of a protective shell permits the use of “relay activators” in the particles, i.e. those activators having a meta stable energy level of the activator that is equal to, below, or approximately the same as the sensitiser excited state level. An example of core-shell particles of this type are particles having a core comprising NaYF₄Yb:Er and a NaYF₄ shell.

A protective shell may also be employed where a meta stable energy level of the activator exists below the sensitiser excited state level. An example of a core-shell particle of this type is depicted in FIG. 12. An further example of core-shell particles of this type are particles having a core comprising NaYF₄Yb:Tm and a NaYF₄ shell.

In embodiments of the invention the activator concentration of the particles and the irradiance may be chosen depending on the particular application, such as the type of emission desired (see FIG. 7). With reference to FIG. 7, when blue emission is a priority 2 mol % Tm³⁺ nanocrystals are preferred for a large excitation range, whereas 6 mol % Tm³⁺ nanocrystals are suitable for generating infrared emission when the irradiance reaches 10⁵ W/cm², which is typically 1 mW in a 1 μm² cross-sectional area, such as used in laser confocal microscopy.

The luminescence decay lifetimes of the particles may be modulated by varying the concentrations of the activator and the sensitiser. The method, system and particles described herein may therefore find application in time-domain multiplexing coding and decoding.

FIG. 8 shows, upconversion emission intensity at seven wavelengths versus Tm³⁺ doping concentrations from 0.2 mol % to 8 mol % at irradiance values of 0.22×10⁶ W/cm² and 2.5×10⁶ w/cm². This data enables convenient selection of the most appropriate nanocrystals based on irradiance and the desired upconversion emission spectra. For example, where infrared emission is desired and high irradiance is to be used, 8 mol % Tm³⁺ doping concentrations would be preferred.

The methods described herein for optimisation of upconversion luminescence make it possible to significantly extend the detection limit of the particles in advanced imaging and sensing applications, such as for example fibre dip sensors. The detection limits of fluorescent quantum dots in such fibres are in the range of about 10 pM and Er³⁺ upconversion nanocrystals are in the range of about 660 fM due to the competing autofluorescence background from the fibre itself. The inventors have found that by using 4 mol % Tm³⁺ upconversion nanocrystals it is possible to enhance the upconversion signal via increased activator concentration and to avoid the fibre autofluorescence problem by monitoring several distinct emission peaks of Tm³⁺ as shown in FIG. 4a. As demonstrated in Example 4, the inventors have been able to detect nanocrystals at a concentration of 39 fM in a 20 nL suspension. This outstanding detection limit renders the nanocrystals particularly suitable as labelling agents for trace analysis, particularly in microstructured optical fibre sensors.

In another embodiment there is provided a system for capturing upconversion luminescence comprising: a suspended-core optical fibre comprising particles, the particles comprising a host material, an activator and a sensitiser, a laser beam for exciting the is particles to produce upconversion luminescence, and a spectrometer for capturing the luminescence. The laser beam may subject the particles to an irradiance value or values as defined in accordance with the first aspect. The particles may be as defined in accordance with the first, second or third aspects.

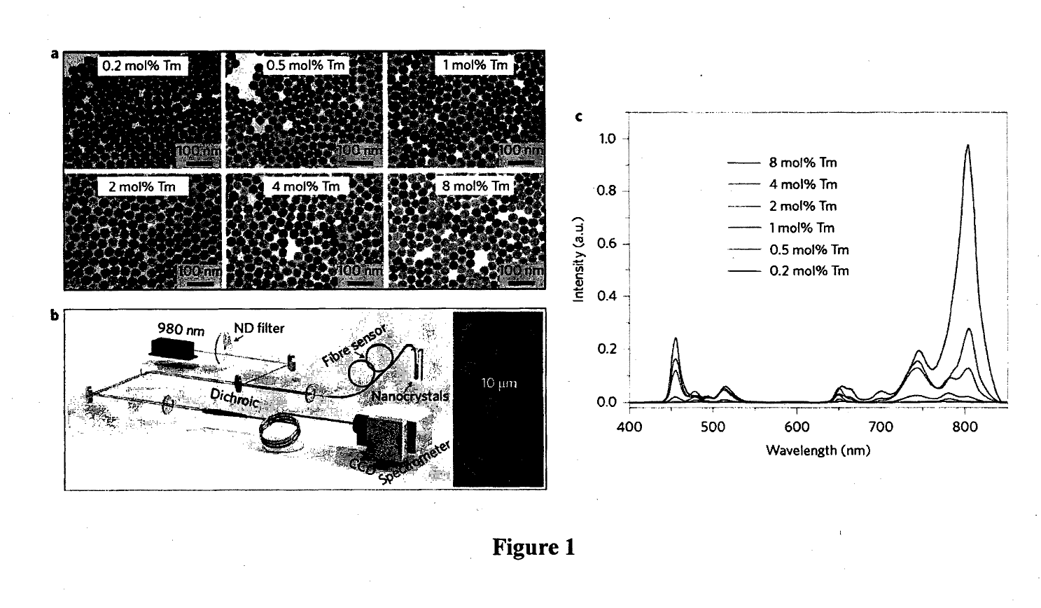

A system in accordance with one embodiment is shown in FIG. 1b. In this embodiment a solution comprising nanocrystals enters one end of a suspended-core microstructured optical fibre and travels through the suspended core along part or the entire length of the fibre by capillary action. The end of the fibre is then withdrawn from the solution and a 980 nm CW diode laser beam is delivered to the suspended core via the opposite end of the fibre to that where the solution entered. Delivery of the laser creates a strong interaction with the nanocrystals located within the suspended core. The incident infrared light propagates along the length of the fibre, while the luminescence signal produced is coupled into the fibre core and propagates in the opposite direction to the incident infrared light to a location where it is captured by a spectrometer.

FIG. 9 provides a block diagram setting out the steps for capturing upconversion luminescence in accordance with an embodiment of the fourth aspect.

### EXAMPLES

The invention will now be described in more detail, by way of illustration only, with respect to the following examples. The examples are intended to serve to illustrate this invention and should in no way be construed as limiting the generality of the disclosure of the description throughout this specification.

### Example 1

### Synthesis and Characterisation of Yb/Tm-doped NaYF₄ Nanocrystals

Hexagonal-phase NaYF₄ nanocrystals with Tm³⁺ concentrations in the range 0.2-8 mol % and co-doped with 20 mol % Yb³⁺ were synthesised (see FIG. 1b). The following reagents were used: YCl₃.6H₂O (99.99%), YbCl₃.6H₂O (99.998%), TmCl₃.6H₂O (99.99%), ErCl₃.6H₂O (99.9%), NaOH (98%), NH₄F (99.99%), oleic acid (OA, 90%), 1-octadecene (ODE, 90%) were purchased from Sigma-Aldrich. Unless otherwise noted, all chemicals were used as received without further purification.

Upconversion NaYF₄:Yb,Tm nanocrystals were synthesized using organometallic methods described previously (see Liu, Y. S. et al. A Strategy to Achieve Efficient Dual-Mode Luminescence of Eu³⁺ in Lanthanides Doped Multifunctional NaGdF₄ Nanocrystals. Adv Mater 22, 3266 (2010); and Wang, F. et al. Simultaneous phase and size control of upconversion nanocrystals through lanthanide doping. Nature 463, 1061-1065, (2010)). Briefly, 5 ml of a methanolic solution of LnCl₃ (1.0 mmol, Ln=Y, Yb, Tm/Er) was magnetically mixed with 6 ml OA and 15 ml ODE in a three-neck round-bottom flask. The resulting mixture was heated at 150 ° C. under argon flow for 30 min to form a clear light yellow solution. After cooling down to 50 ° C., 10 mL of a methanolic solution containing 0.16 g NH₄F and 0.10 g NaOH was added with vigorous stirring for 30 min. Then, the slurry was slowly heated and kept at 110 ° C. for 30 min to remove methanol and residual water. Next, the reaction mixture was protected with an argon atmosphere, quickly heated to 305° C. and maintained for 1.5 h. The products were isolated by adding ethanol and centrifugation without size-selective fractionation. On occasions the final NaYF₄:Yb,Tm nanocrystals were redispersed in cyclohexane with 5 mg/ml concentration after washing with cyclohexane/ethanol.

For characterisation, powder X-ray diffraction (XRD) patterns were obtained on a PANalytical X'Pert Pro MPD X-ray diffractometer using Cu Kul radiation (40 kV, 40 mA, λ=0.15418 nm). Transmission electron microscope (TEM) measurements were performed using a Philips CM10 TEM with Olympus Sis Megaview G2 Digital Camera. The samples for TEM analysis were prepared by placing a drop of a dilute suspension of nanocrystals onto formvar-coated copper grids (300 mesh). The XRD patterns are shown in FIG. 5a.

### Example 2

### Excitation of the Yb/Tm-Doped NaYF₄ Nanocrystals

A single-mode 980 nm diode laser beam was launched into a suspended-core fibre (see FIG. 1a) which guides and concentrates the excitation within the core of the fibre so that variable high-irradiance excitation in the range of 1.6×10⁴ to 2.5×10⁶ W/cm² can be achieved to excite suspended nanocrystals in the proximity of the fibre core. It was observed that at an irradiance of 2.5×10⁶ W/cm², the 8 mol % Tm³⁺ nanocrystals farther exceed the performance of the other doping concentrations, with infrared and blue emission bands significantly stronger than for 0.5% Tm³⁺ nanocrystals (802 nm emission more than 70 times stronger; shown in FIG. 1c). The power-enabled reversal of concentration quenching resulted in an increased integrated upconversion signal, by factors of 5.6, 71 and 1105 for 0.5%, 4%, and 8% Tm³⁺, respectively, compared to the integrated upconversion signals at low irradiance of 1.6×10⁴ W/cm². At low irradiation of 10 W/cm² the results herein show that upconversion intensity as a function of Tm³⁺ concentration increases and then decreases as reported previously and interpreted as concentration quenching (see FIG. 5).

### Example 3

### Power-Dependent Luminescence Spectra of Upconversion Nanocrystals having Varying Tm³⁺ Concentrations

To quantify the analysis above in Example 2 a matrix of power-dependent (1.6×10⁴ up to 2.5×10⁶ W/cm²) luminescence spectra from six samples of upconversion nanocrystals with Tm³⁺ concentrations ranging from 0.2′mol % to 8 mol % were collected. With, reference to the simplified excited-state levels in FIG. 2a, the emission spectra may be grouped into three populations: “two-photon excitation level” (³H₄ level emitting at 802 nm), “three-photon excitation level” (¹G₄ level emitting at 650 nm and 480 nm) and “four-photon excitation level” (¹D₂ level emitting at 455 nm, 514 nm, 744 nm and 782 nm). With a representative Example shown in FIG. 2b, the spectrum-covered areas extracted from Gaussian curve fittings at each wavelength offer quantitative data indicating how significantly the sensitized 980 nm photons contribute to individual upconversion emission wavelengths. Clearly, the emissions at 802 nm, 650 nm, 744 nm and 782 nm have been converted by two additional sensitized 980-nm photons in an equilibrium system, and the 480 nm, 455 nm and 514 nm emissions need three sensitized 980-nm photons to maintain continuous emissions, assuming all upconverted photons on ¹D₂, ¹G₄, and ³H₄ levels eventually emit upconversion luminescence (negligible consumption via other non-radiative pathways). Subsequently, a ratio-metric analysis showed how the sensitised 980 nm photons can populate various Tm³⁺ excited states at different irradiance levels in selected nanocrystals (see FIG. 2c). At low Tm³⁺ doping concentration (0.5 mol %), the 3-photon excitation level ¹G₄ and 4-photon excitation level ¹D₂ are readily populated at relatively low irradiance (˜10⁴ W/cm²), and then the increased excitation irradiance (>2×10⁴ W/cm²) starts to provide sufficient excited Yb³⁺ sensitizers to pump more 3-photon (¹G₄ level) and 4-photon (¹D₂ level) emission, so that the respective ratios of 3- or 4-photon emission intensity to 2-photon (³H₄ level, 802 nm) emission intensity reach plateaus of ˜2.8 and ˜4.5 at an irradiance intensity of 10⁶ W/cm². Un-flat plateau of the ratios ('G₄: ³H₄ and ¹D₂:³H₄) can be a sign that higher Tm³⁺ concentration (1 mol % to 4 mol %) ensures that more of the sensitized Yb³⁺ ions transfer their excitation to facilitate 802 nm emission. For the 8 mol % Tm³⁺ nanocrystals, within the excitation range from 10⁴ to 10⁶ W/cm² there is a clear tendency to mainly produce 802 nm emission as a result of the decreased ratio of ¹G₄: ³H₄ and ¹D₂:³H₄. In the case of the 0.2 mol % Tm³⁺ nanocrystals excitation irradiance greater than 10⁴ W/cm² produces an excess of sensitized 980 nm photons leading to increased 5-photon excitation level emission from the ¹I₆ excited state.

The selected evolution of spectra for 0.5 mol %, 4 mol %, and 8 mol % Tm³⁺ as a function of excitation reveals the weight for multiple emission peaks (see FIG. 6). From the increase in 3-photon and 4-photon emissions with increasing excitation irradiance it is clear that in order to obtain efficient upconversion emission from high Tm³⁺-doped nanocrystals (such as 8 mol %) it, is necessary to have sufficient excitation power.

To further explore the factors that contribute to upconversion enhancement, FIG. 3a shows the power-dependent upconversion efficiency curves of different nanocrystals, measured by the emission from the ¹D₂, ¹G₄, and ³H₄ levels, which indicates an increase in the number of Tm³⁺ ions can dramatically amplify the upconversion signal level at the elevated irradiance excitation. FIG. 3b shows the power-efficiency curves averaged by the Tm³⁺ number within different nanocrystals. The significant enhancement per Tm³⁺ ion from 1 mol % to 2 mol % clearly shows that the energy transfer efficiency from Yb³⁺ sensitisers to Tm³⁺ activators has been significantly enhanced, since the upconverted photons from the ¹D₂, ¹G₄, and ³H₄ levels dominate the emission as discussed above in FIG. 2c. This indicates that the decreased sensitiser-to-activator distance increases energy transfer efficiency, thereby contributing to enhancement of the overall upconversion efficiency per nanocrystal.

### Example 4

### Detection Limit of the Nanocrystals

In order to establish the potential of Tm³⁺ upconversion nanocrystals as fluorescent probes for trace-molecular detection, NaYF₄:Yb/Tm (20/4 mol %) nanocrystals in cyclohexane at various dilutions were introduced into microstructured fibres, as described. above. The Tm³⁺ emission was clearly detectable at a level of 5 ng/mL, corresponding to 39 fM nanocrystals in a 20 nL suspension (which is equivalent to approximately 635 nanocrystals distributed along about a 12 cm long fibre sensor) as shown in FIG. 4a.

To further investigate the detection limit, 8 mol % Tm³⁺ nanocrystals were diluted to 3.9 fM. Interestingly, a digitized signal of ˜30 counts was observed (as background noise), ˜250 counts (220 net counts) and ˜470 counts (440 net counts) for the 802 nm emission, as shown in FIGS. 4b-d. Four tests out of 10 gave ˜250 positive counts and six tests gave ˜30 counts as shown in FIG. 4b. The peak intensity of the light at the glass:air interface drops off to 1/e at a distance of 0.125 μm, so that the optically effective area (from the glass core surface till the 1/e of evanescent field, within one hole) can be calculated as 0.143 μm². Thus, the volume ratio of effective fraction to the whole hole (one hole: 51.87 μm²) is ˜0.0027. At a nanocrystal concentration of 3.9 fM, the 12 cm long fibre should contain only ˜47 nanocrystals, with an average of 0.1269 nanocrystals within the optically effective region. The present setup was used to monitor the sample intake process by capillary action and the real-time result is shown in FIG. 3d. A particular signal of ˜470 counts was observed in FIG. 4d, corresponding to a doublet event (two nanocrystals) in the evanescent field. This further confirms that single nanocrystal sensitivity has been achieved using the nanowire suspended-core optical fibre. As such, the extreme brightness of individual nanocrystal emissions achieved at high irradiance excitation enables unparalleled sensitivity of the microstructured fibre as a sensing platform, which is suitable for molecular analysis at a trace level.

### Example 5

### Low-Power High-Contrast STED Nanoscopy Powered by Upconversion Nanocrystals

Confocal microscopes, though widely used in cell biology labs, only give optical resolution approaching the theoretical Abbe diffraction limit of ˜200 nm, larger than DNA, RNA, proteins, and cytoskeletons (5-50 nm). Super-resolution microscopy, wherein the diffraction limit of light is overcome, has been the subject of several major developments during the past decade. STimulated Emission Depletion (STED) can be used as an approach to achieving super-resolution in fluorescence microscopy. In one example, STED uses an intense doughnut-shaped laser beam to trim the primary excitation focus by “switching off” the surrounding excited fluorophore(s) through a stimulated emission pathway (“de-excitation”). The spatial resolution achieved in STED microscopy is strongly dependent on the intensity of the depletion-laser beam: for standard biolabels (e.g. Alexa Fluor, and Atto dyes) lateral resolution of 62 nm has been reported for depletion-laser intensity of 400 MW/cm², while resolution of 8 nm has been reported for depletion-laser intensity 3.7 GW/cm². However, such large laser intensities commonly cause photobleaching of the biolabels and photo-thermal damage to the fragile sub-cellular structures of biological samples. Other associated issues, such as the laser complexity, stability and cost, are also becoming major impediments to advanced applications of STED in cell biology. Thus, a critical advance needed to extend the capabilities of STED microscopy in biomedical research is a new way to achieve high stimulated emission depletion factors (switch-off) at low laser pump intensities.

The fundamental problem of very high depletion pump intensities arises from the short (nanosecond) lifetimes of the biolabels used in STED. The depletion intensity is inversely proportional to the fluorescence lifetime of the target fluorophore, thus intensities of 10⁸˜10⁹ W/cm² are needed in the depletion pump beam. This requires precisely synchronizing a pulsed laser within a very short time window or a CW synchronization-free laser of hundreds of milliwatts; both approaches are challenging, and in the case of “soft materials” impractical. Consistent with theory, it has previously been suggested that a solution to this problem is to employ target fluorophores with much longer lifetimes to reduce the depletion-intensity requirements commensurately. However, implementation of this simple idea has been precluded by the lack of practical fluorescent or luminescent materials or particles which have the requisite long lifetimes, are sufficiently bright and have sufficient depletion cross-section.

This offers another example application for the previously discussed upconversion particles/materials. The inventors use a lanthanide-based luminescent nanomaterial, being bright with both long excited-state lifetime and large depletion cross-section, suitable for low power stimulated emission depletion. The inventors found that the critical factors of both brightness and large depletion cross-section are only accessible by significantly increasing the doping concentration of activators in the upconversion nanocrystals. This condition has only become accessible after the inventors surprisingly realised the optimum concentration was power-dependent, as previously discussed. Sufficient excitation power (i.e. irradiance) under a laser scanning confocal microscope has been used to overcome the fundamental barrier of so-called concentration quenching (e.g. 0.5 mol % Tm³⁺), allowing tens of thousands of photostable emission centres (e.g. up to 8 mol % Tm³⁺) to be densely packed into a single dot.

Moreover, the ladder-like arranged energy levels in these crystals provide multiple intermediate excited states for the step-wise upconversion process, so that by. indirectly depleting the lower intermediate states it is possible to effectively switch “off” the higher level emissions. In comparison to current STED techniques, which use fluorescence biolabels, the advantages of this technique include high contrast in on-to-off ratio and high depletion efficiency.

An upconversion approach enables separation of the depletion wavelength from excitation wavelength. Clear separation of the de-excitation wavelength from the absorption wavelength is important, otherwise the depleted molecule may be re-excited by the strong depletion beam when the excitation spectra and emission spectra overlap. This overlap occurs for most fluorochromes used in STED, so that re-excitation caused by the depletion beam has been one of the major limitations for most dyes (including quantum dots), where depletion was chosen at the red-shifted tail of the emission band in STED.

To test the depletion efficiency, a single-mode 976 nm laser was employed as the primary excitation source in a confocal microscopy setup (x-y-z stage scan), and an 808 nm single-mode laser was coupled to the primary beam. Precision nanophotonics engineering was applied to ensure the two confocal beams precisely overlap through a high-performance objective. This setup allowed testing of the depletion efficiency of Tm³⁺-doped upconversion nanocrystals. While an upconversion nanocrystal with a conventional doping concentration of 0.5 mol % was difficult to switch off (they are even less efficient than the best-performing dye, Dylight 650, depleted at 783 nm in our previous CW STED system), a high doping concentration of 6 mol % Tm³⁺ was surprisingly easy to deplete. Indeed the upconversion nanocrystals were fully depleted at sub-milliwatt levels, three orders of magnitude lower power than the 0.5% crystals (see FIG. 14).

To evaluate the optical resolution of upconversion particle based powered high-contrast STED nanoscopy, a phase plate was employed to generate an 808 nm “doughnut” PSF surrounding the excitation PSF to form the STED nanoscopy architecture. The efficacy of the new generation of luminescent upconversion particles and intermediate optical pumping scheme was evaluated for single nanocrystal STED imaging (refer to FIG. 15B) comparing to the conventional confocal resolution imaging results (refer to FIG. 15A). At only a depletion intensity of <5 MW/cm², the resolution of STED was significantly improved from about 427 nm to about 88 nm.

Application of the upconversion particles in this manner provides luminescent biolabels that feature multiple, long-lived intermediate excited states, and produce bright and sharp luminescence emissions. Thus, this example application solves the main limitation of current STED-based super-resolution microscopy, namely that the high laser powers required to deplete the fluorescent dyes, and so achieve sub-100 nm resolution, also cause photobleaching and sample damage, thereby limiting the utility of the technique. Use of upconversion particles can provide important opportunities for practical improvements in super-resolution microscopy.

### Example 6

### Security Inks

Excitation-dependent upconversion particles also enable a new approach to security inks, because highly doped (typically>4 mol %) Tm³⁺ nanocrystals remain dark unless high infrared excitation irradiance is used, in contrast to low level doped Tm³⁺ nanocrystals. Additionally, nanocrystal suspensions can be dispersed in traditional inkjet printer inks to print highly secure images, such as trademarks or logos, on papers and plastics.

FIG. 16 shows an example application for security inks. Images for the “University of Adelaide” and the Sydney harbour bridge were printed using mask ink having 0.2 mol % Tm upconversion nanocrystals, and images for “Macquarie University” and the fireworks about the Sydney harbour bridge were printed using a security ink having 4 mol % Tm upconversion nanocrystals. The low power excitation was about 10⁴ W/cm², the high power excitation was about 10⁶ W/cm².

This demonstration shows an application for security inks using power dependent Tm³⁺ concentration. In another example, low concentration (for example, 0.2 mol % Tm³⁺) nanocrystals can be used to stain a masking pattern which is visible under both low power illumination (about 10⁴ W/cm²) and high power illumination (about 10⁶ W/cm² or greater). High concentration (for example, 4 mol % Tm³⁺) nanocrystals can be used to stain a hidden pattern (e.g. the Macquarie University logo or the fireworks in FIG. 16), which can be over 10 times brighter than the masking pattern. Depending on the dynamic range, the masking pattern can be set to be almost unnoticeable if desired. Nanocrystal solution ‘security inks’ can be used in an inkjet printer at various concentrations, for example with 0.5 mol % Tm³⁺ nanocrystals as a mask to confound a signal image from 8 mol % Tm³⁺ nanocrystals. At a laser scanning confocal setting of greater than about 1×10⁶ W/cm² a hidden pattern or image from the printed 8 mol % Tm³⁺ nanocrystals becomes visible and dominant.

### Example 7

### Bulk Materials

Efficient upconversion emission can be realized at a high activator doping, but only when sufficient irradiance is provided. Sufficient excitation irradiance can unlock otherwise dark activators, thereby enhancing the upconversion brightness. This effect is independent of particle or crystal size (for example from tens to several hundreds of nanometres, to ‘bulk material’), surface conditions and synthesis conditions.

This effect in bulk crystals is demonstrated in FIG. 17 which shows example power dependent single bulk crystal measurements under wide-field upconversion luminescence microscope. Figures a) and b) are TEM images of as-prepared bulk crystals at Tm³⁺ doping concentration of 8 mol % and 2 mol % respectively; c) and d) are luminescence images in the visible range (400˜700 nm) at excitation power density of 0.1×10⁶ W/cm², and e) and f) are taken at higher excitation of 5×10⁶ W/cm² for 8 mol % Tm³⁺ and 2 mol % Tm³⁺ single bulk crystals, respectively. All the luminescence images are produced at the same CCD exposure time of 60 milliseconds. g) shows power-dependent intensities (integrated over 400˜850 nm range) of the same single bulk crystals measured by a single-photon counting avalanche diode (SPAD).

Various other applications using the upconversion particles are possible. For example, in detection, sensing, imaging, such as of biological material, flow cytometry, solar cell or display applications. A sensing application may be, for example, a fibre sensing method, such as a fibre dip sensing method. Display applications can include televisions and monitors.

The exceptional nanocrystal brightness provides compelling advantages to a wide range of fields including immunofluorescence imaging, rare event cell detection and quantification, document security and security printing. The ultrabright upconversion nanocrystals can be used to provide high-contrast biolabels. As a further illustrative example, Giardia lamblia cells can be labelled by nanocrystals conjugated to suitable monoclonal antibodies (G203). The labelled Giardia cells can be imaged by a scanning system at only about 0.1 s exposure time by a standard charge-coupled device (CCD) camera. The absence of autofluorescence background at 980 nm excitation enables the quantification of the absolute signal intensities of each single microorganism, as well as quantification of the level of surface antigens. Single labelled cells on a glass slide have been detected within 3 min without background interference. This shows that these bioprobes are capable of rare event detection.

Those skilled in the art will appreciate that the invention described herein is susceptible to variations and modifications other than those specifically described. It is to be understood that the invention includes all such variations and modifications.

The reference in this specification to any prior publication (or information derived from the prior publication), or to any matter which is known, is not, and should not be taken as an acknowledgment or admission or any form of suggestion that the prior publication (or information derived from the prior publication) or known matter forms part of the common general knowledge in the field of endeavour to which this specification relates.

1. A method for enhancing upconversion luminescence of rare-earth doped particles comprising a host material, a sensitiser and an activator, wherein the particles have an activator concentration of at least about 1 mol %, and the method comprising subjecting the particles to an irradiance of at least about 10³ W/cm².

2. (canceled)

3. The method of claim 1, wherein enhancing upconversion luminescence involves enhancing luminescence intensity and/or brightness and/or upconversion efficiency.

4. The method of claim 1, wherein the method comprises subjecting the particles to an irradiance which is sufficient to overcome or reverse concentration quenching of upconversion luminescence.

5. The method of claim 1, wherein the method comprises subjecting the particles to an irradiance which is sufficient to cause population of an upconversion energy state of the activator.

6. The method of claim 1, wherein the activator has an intermediate meta stable energy level which accepts resonance energy from the sensitiser excited state level.

7. The method of claim 1, wherein the particles are configured to reduce, minimize or exclude quenchers from between the sensitiser and the activator.

8. The method of claim 1, which comprises subjecting the particles to an irradiance of at least about 10⁴ W/cm², or at least about 10⁵ W/cm², or at least about 10⁶ W/cm², or at least about 10⁷ W/cm², or at least about 10⁸ W/cm², or at least about 10⁹ W/cm², or at least about 10¹° W/cm², or at least about 10¹¹ W/cm², or at least about 10¹² W/cm².

9. The method of claim 8, which comprises subjecting the particles to an irradiance of between about 1×10⁴ and 5×10⁶ W/cm², or between about 1.6×10⁴ and 2.5×10⁶ W/cm².

10. The method of claim 1, wherein the irradiance is infrared or near-infrared irradiance.

11. (canceled)

12. The method of claim 1, wherein the particles have an activator concentration of at least about 0.5 mol %, or at least about 1 mol %, or at least about 2 mol %, or at least about 3 mol %, or at least about 4 mol %, or at least about 5 mol %, or at least about 6 mol %, or at least about 7 mol %, or at least about 8 mol %, or at least about 10 mol %, or at least about 12 mol %, or at least about 14 mol %, or at least about 16 mol %, or at least about 18 mol % or at least about 20 mol %.

13. The method of claim 1, wherein the particles have an activator concentration between about 1 mol % and 30 mol %, or between about 1 mol % and 25 mol %, or between about 1 mol % and 20 mol %, or between about 1 mol % and 15 mol %, or between about 2 mol % and 15 mol %, or between about 4 mol % and 15 mol %, or between about 4 mol % and 8 mol %.

14. The method of claim 1, wherein the activator is selected from the group consisting of: Tm³⁺, Er³⁺, Dy³⁺, Sm³⁺, Ho³⁺, Eu³⁺, Tb³⁺ and Pr³⁺.

15-17. (canceled)

18. The method of claim 1, wherein the particles have a sensitiser concentration in the range of about 10 mol % to about 95 mol %, or about 20 mol % to 90 mol %, or about 20 mol % to 80 mol %, or about 30 mol % to 80 mol %, or about 40 mol % to 80 mol %, or about 20 mol % to 40 mol %.

19. The method of claim 1, wherein the sensitiser is Yb³⁺, Gd³⁺, Nd³⁺ or Ce³⁺.

20. The method of claim 1, wherein when the sensitiser is Yb³⁺ and the activator is Tm³⁺, the method comprises subjecting the particles to an irradiance which is sufficient to cause population of the ³H₄ energy level and/or higher energy levels including the ¹G₄ and ¹D₂ energy levels of the Tm³⁺.

21. The method of claim 1, wherein the host material is selected from the group consisting of: an alkali fluoride, an oxide and an oxysulfide.

22-26. (canceled)

27. A system for enhancing upconversion luminescence comprising:
rare-earth doped particles comprising a host material, a sensitiser and an activator, wherein the particles have an activator concentration of at least about 1 mol %; and
a source of irradiance for subjecting the particles to an irradiance of at least about 10³ W/cm².

28. Rare-earth doped particles comprising a host material, a sensitiser and an activator, wherein the sensitiser is present in a concentration of at least about 20 mol %, and wherein the activator is present in a concentration of at least about 1 mol %.

29. The particles of claim 28, wherein the sensitiser is present in a concentration of at least about 25 mol %, at least about 30 mol %, at least about 40 mol %, at least about 50 mol %, at least about 60 mol %, at least about 70 mol %, at least about 80 mol %, or at least about 90 mol %,

30. The particles of claim 28, wherein the activator is present in a concentration of at least about 2 mol %, at least about 4 mol %, at least about 5 mol %, at least about 10 mol %, at least about 15 mol %, at least about 20 mol %, at least about 25 mol %, or at least about 30 mol %.

31. (canceled)

32. (canceled)

33. The particles of claim 28, wherein the activator has an intermediate meta stable energy level which accepts resonance energy from the sensitiser excited state level.

34. The particles of claim 28, which are configured to reduce, minimize or exclude quenchers from between the sensitiser and the activator.

35. The particles of claim 34, which are core-shell particles wherein the core comprises the host material, sensitiser and the activator, and the shell comprises a material which prevents, retards or inhibits surface quenching.

36. The particles of claim 28, wherein the sensitiser is Yb³⁺ and the activator is Er³⁺, Ho³⁺ or Tm³⁺.

37. The particles of claim 28, wherein the particles are nanoparticles, nanocrystals, microparticles, microcrystals or a bulk material.

38. (canceled)

39. (canceled)
